(19) United States
(12) Patent Application Publication
(10) Pub. No.: US 2026/0288879 A1
(43) Pub. Date: Sep. 24, 2026

(54) SYSTEM

(71) Applicant: SoftBank Group Corp., Tokyo (JP)

(72) Inventor: Tsukasa SEKITA, Tokyo (JP)

(73) Assignee: SoftBank Group Corp., Tokyo (JP)

(21) Appl. No.: 19/568,786

(22) Filed: Mar. 17, 2026

(30) Foreign Application Priority Data
Mar. 19, 2025 (JP) 2025-045031

(51) Int. Cl. G06F 16/93; G06N 3/0475; G06N 20/20

(52) U.S. Cl. CPC G06F 16/93; G06N 3/0475; G06N 20/20

(57) ABSTRACT

A system includes a processor that is configured to perform demand forecasting by using a generative artificial intelligence model and taking into account recent trend information, broadcast schedules of information media, past sales data, and a user's emotional state, generate, based on the demand forecasting, a list of items required for ordering, generate a prompt that instructs automation of ordering operations in cooperation with a plurality of suppliers, and cause execution of the ordering operations via a communication interface, and generate, based on ordering information, a prompt by using the generative artificial intelligence model, automatically design an advertising material in accordance with the prompt, and place an order to a printing vendor for printing the advertising material via the communication interface.

### CROSS-REFERENCE TO RELATED APPLICATION

This application is based on and claims priority under 35 USC 119 from Japanese Patent Application No. 2025-045031 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional retail and distribution management systems, demand forecasting, ordering operations, and advertising material creation are often performed as separate and largely manual processes. Demand forecasting typically relies only on historical sales data and simple trend indicators, without fully incorporating dynamic external factors such as recent media exposure or nuanced user-related information such as emotional state. As a result, prediction accuracy is limited, leading to stock-outs or overstock situations and inefficient inventory management.

Furthermore, ordering operations to a plurality of suppliers are usually carried out by human operators who interpret forecast results, create order lists, and manually interact with suppliers' systems. This manual workflow is time-consuming, error-prone, and difficult to scale, especially when the number of items, stores, and suppliers increases. Additionally, the creation and design of advertising materials, such as flyers or digital advertisements, are often handled separately by marketing personnel or external agencies, based on partial and delayed information about ordering and inventory, which can cause inconsistencies between actual product availability and advertised content.

Existing systems also do not effectively utilize advances in generative artificial intelligence to unify these processes. In particular, they do not generate structured prompts that instruct generative models to automate complex workflows across demand forecasting, ordering, and advertising design. Moreover, emotional data of users, which can influence purchasing behavior and campaign effectiveness, is rarely integrated into demand forecasting or promotional design. Therefore, there is a need for a system that can: (i) perform more accurate demand forecasting by incorporating trend information, media broadcast schedules, past sales data, and user emotional state; (ii) automatically generate and execute ordering workflows through cooperation with multiple suppliers via a communication interface; and (iii) automatically design advertising materials and place print orders, all in a coordinated and efficient manner.

### SUMMARY

To solve the above problems, an embodiment of the invention provides a system comprising a processor configured to use a generative artificial intelligence model as a core component that unifies demand forecasting, ordering automation, and advertising material design.

In one aspect, the processor is configured to perform demand forecasting by using the generative artificial intelligence model while taking into account multiple heterogeneous factors including recent trend information, broadcast schedules of information media, past sales data, and a user's emotional state. By integrating these heterogeneous data sources, the processor generates richer input features that capture real-time market dynamics and user behavior, thereby improving the accuracy and responsiveness of the demand forecasting compared to conventional methods that rely only on historical sales.

In another aspect, the processor is configured to generate, based on results of the demand forecasting, a list of items required for ordering and to generate a prompt that instructs automation of ordering operations in cooperation with a plurality of suppliers. The processor causes execution of the ordering operations via a communication interface, for example by calling supplier application programming interfaces or electronic data interchange endpoints, so that purchase orders corresponding to the generated item list are automatically created and transmitted without requiring manual data re-entry or ad-hoc communication by human operators.

In a further aspect, the processor is configured to generate, based on ordering information, a prompt by using the generative artificial intelligence model and to automatically design advertising material in accordance with the prompt. The advertising material may include layout, product arrangement, pricing indications, and promotional messages that are consistent with the forecasted demand and actual ordered quantities. The processor then places an order to a printing vendor for printing the advertising material via the communication interface, thereby ensuring that printed advertising materials are automatically produced and aligned with the underlying inventory and promotional strategy. In certain embodiments, the processor performs the demand forecasting by using a machine learning algorithm and integrates user emotion data into the forecasting model to further improve prediction accuracy, and performs the automation of the ordering operations in cooperation with the plurality of suppliers while providing information in real time to store staff via a smart device. Through these means, the invention enables an integrated and automated pipeline from demand prediction to ordering and advertising material production, reducing manual workload, mitigating errors, and enhancing the timeliness and effectiveness of retail operations.

The term “system” refers to an arrangement of one or more hardware components, software components, or a combination thereof, that cooperatively perform the functions described in the claims.

The term “processor” refers to any hardware device or combination of hardware devices configured to execute instructions, including but not limited to a central processing unit (CPU), a graphics processing unit (GPU), a microcontroller, an application specific integrated circuit (ASIC), a field programmable gate array (FPGA), or a combination of these.

The term “generative artificial intelligence model” refers to a software-implemented model, such as a neural network, that is trained to generate outputs including text, images, prompts, or other data based on input data or conditions.

The term “demand forecasting” refers to a process of predicting future demand or sales quantities for one or more items over a future time period based on historical data, external factors, or other input information.

The term “recent trend information” refers to data representing short-term changes or tendencies in consumer interest, market behavior, or item popularity, which may be derived from sources such as search statistics, social media activity, sales trends, or other timely indicators.

The term “broadcast schedules of information media” refers to data identifying planned or actual broadcast times, dates, and content descriptions of programs or content delivered via media such as television, radio, streaming services, or online video platforms.

The term “past sales data” refers to historical records of transactions, including sales quantities, prices, dates, times, and related metadata for items sold in the past.

The term “user's emotional state” refers to information representing or estimating the emotional condition of a user, such as happiness, dissatisfaction, excitement, or stress, which may be obtained or inferred from explicit input, biometric signals, behavioral data, or interaction logs.

The term “list of items required for ordering” refers to data that specifies one or more items to be procured, including at least an identifier of each item and a corresponding quantity or other ordering parameter.

The term “prompt” refers to a data structure or content, such as text, structured text, or parameterized instructions, provided as input to a generative artificial intelligence model or another automated system in order to cause execution of a specific task or workflow.

The term “automation of ordering operations” refers to execution of operations for placing purchase orders, including generating order data, transmitting the order data to suppliers, and managing related communication, without requiring manual entry of order details by a human operator.

The term “plurality of suppliers” refers to two or more distinct supplier entities, each capable of providing one or more items through an ordering interface.

The term “communication interface” refers to hardware and/or software components that enable data exchange between the system and external devices or systems, including but not limited to network interfaces, application programming interfaces (APIs), or electronic data interchange (EDI) interfaces.

The term “ordering information” refers to data related to one or more purchase orders, including item identifiers, quantities, prices, suppliers, delivery dates, and statuses of the orders.

The term “advertising material” refers to content intended for promotion or marketing, including but not limited to flyers, leaflets, posters, catalogs, or other print or digital media that present items, prices, campaigns, or messages to consumers.

The term “printing vendor” refers to an external entity or service provider that receives printing requests and produces physical printed materials, such as flyers or posters, based on data supplied by the system.

The term “machine learning algorithm” refers to a computational method or model that is trained using data to learn patterns or relationships and that can generate predictions or classifications without being explicitly programmed with rules for each possible input.

The term “emotion data of the user” refers to data that represents, estimates, or encodes the emotional state or emotional responses of a user, including numerical scores, categorical labels, or derived features based on signals such as voice, facial expression, text input, physiological data, or interaction patterns.

The term “prediction accuracy” refers to a measure of how closely the results of demand forecasting or other predictive processes correspond to actual observed values, and may be quantified by metrics such as error rates, deviations, or statistical accuracy indices.

The term “smart device” refers to a portable or fixed electronic device capable of network communication and user interaction, such as a smartphone, tablet, smart watch, or network-connected handheld terminal.

The term “store staff” refers to employees or personnel associated with a retail store or similar facility who are responsible for tasks such as inventory management, ordering, sales, or customer service.

The term “real time” refers to a mode of operation in which information is provided or updated with a latency sufficiently low to be considered substantially immediate for the intended operational purpose, without significant manual delay.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

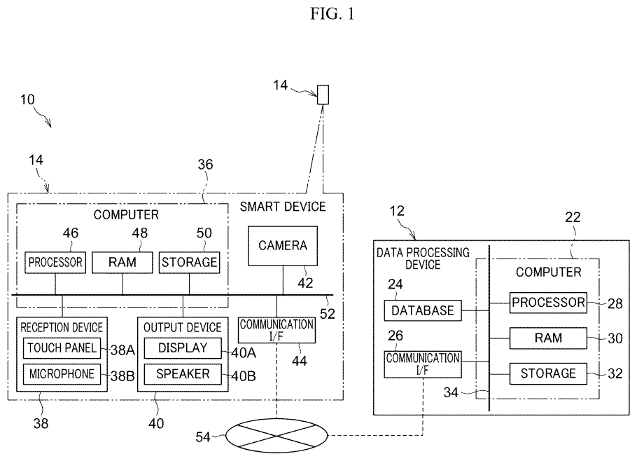

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

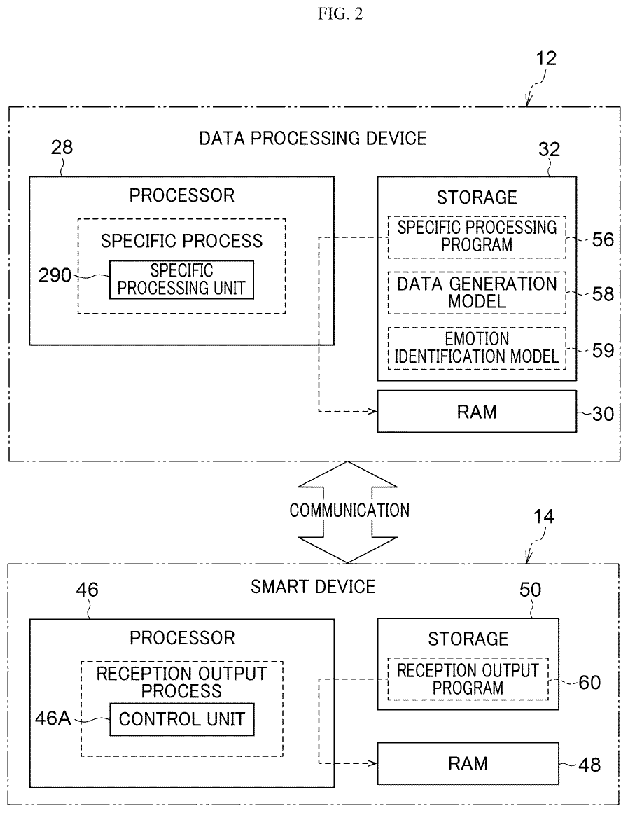

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional demand-forecasting and ordering systems in retail and distribution environments are typically implemented as separate application components that operate on heterogeneous datasets in a batch-oriented manner. These systems generally rely on static rule-based logic or simple statistical models that do not dynamically incorporate real-time external signals, such as rapidly changing trend information and upcoming broadcast schedules distributed over various information media. As a result, the systems often fail to capture abrupt shifts in consumer interest triggered by media exposure, leading to inaccuracies in demand forecasting and suboptimal inventory levels.

Moreover, existing computer-implemented ordering workflows typically require human operators to manually read forecasting results, manually construct order lists in spreadsheet tools or line-of-business applications, and manually enter order information into multiple supplier systems. This fragmented interaction pattern results in redundant data entry, increased latency, and frequent input errors. From a computing-technology perspective, processor resources and network interfaces are underutilized because data flows are not orchestrated end-to-end from forecasting to automated ordering and downstream content generation.

In addition, generation of advertising materials, such as printed leaflets or digital layouts, is frequently decoupled from the demand-forecasting and ordering subsystems. Designers or marketing staff must manually interpret procurement data, manually draft advertising text, and manually place product information into layout applications. This manual translation of structured procurement data into unstructured advertising content introduces friction and inconsistency. The underlying information processing apparatus is not configured to treat procurement data and advertising data as linked data structures that can be processed in a unified pipeline, which results in duplicated storage access, additional user interface operations, and inconsistent data versions across subsystems.

Further, while generative AI models have recently become available as remote services, conventional systems rarely integrate such models into the core transaction workflow of demand forecasting, ordering, and advertisement generation. When generative AI models are used, they are typically invoked in an ad hoc manner via standalone user interfaces. The integration is not implemented as a deterministic, machine-understandable transaction flow starting from forecast results and ending with confirmed print orders. Consequently, processor-executed operations do not systematically exploit generative AI capabilities to derive advertising text and layout structures from machine-readable procurement data, nor do they feed back ordering and printing status as parameters for subsequent generative processing.

Additionally, existing forecasting models often ignore user emotion information or handle such information only as auxiliary metadata without integrating it into the feature vectors used by the prediction models. This leads to a technical limitation in the model's ability to adapt to shifts in consumer sentiment. From a computer-technology standpoint, feature computation modules and model-execution modules are not architected to seamlessly incorporate emotion signals as first-class input features, which restricts the achievable prediction accuracy and reduces the information throughput and effectiveness of the forecasting pipeline.

Therefore, there is a need for an improved computer-implemented system and server-side architecture in which a processor is configured to (i) acquire and fuse external trend information, broadcast schedule information, sales information, and user emotion information as structured input data for machine-learning-based demand forecasting, (ii) automatically generate and transmit supplier-specific order lists through communication interfaces, (iii) generate prompt sentences for a generative AI model based on order information and ordering results, (iv) receive advertising text and configuration information from the generative AI model, and (v) automatically produce advertisement layout data and print orders. Such a system should reduce manual data transformations, decrease error rates, increase end-to-end throughput between forecasting, ordering, and advertising subsystems, and thereby provide an improvement in the functioning of the computer system itself rather than merely automating a mental process.

The specific processing by the specific processing unit 290 of the data processing device 12 in Example 1 is realized by the following means.

The present invention provides a server comprising a processor and a communication interface, wherein the processor is configured to execute instructions that cause the server to acquire external information including recent trend information and broadcast schedule information of information media, sales information, and user emotion information from one or more data sources, to generate feature quantities from the external information, the sales information, and the user emotion information, and to perform demand forecasting processing by inputting the feature quantities into a prediction model including an ensemble of decision-tree models; to generate order-list information including item information, quantity information, and supply-entity information by using a result of the demand forecasting processing together with inventory information, to aggregate the order-list information for each supply entity, and to transmit, via the communication interface, the aggregated order-list information to one or more external information processing apparatuses so as to automate ordering processing; to generate a prompt sentence for a generative AI model based on the order-list information and on a result of the ordering processing, to transmit the prompt sentence to the generative AI model, and to receive advertising text information and advertising configuration information output from the generative AI model in response to the prompt sentence; to generate layout information for plate-making by associating the advertising text information and the advertising configuration information with the item information and the quantity information included in the order-list information, and to generate advertisement data by generating the layout information for plate-making as an electronic document; and to transmit, via the communication interface, the advertisement data and print-condition information to a print processing apparatus and to receive print request information and print acceptance-state information from the print processing apparatus so as to automate print-order processing. This enables the computer system to implement an integrated technical pipeline in which data structures produced by machine-learning-based demand forecasting are automatically transformed into supplier-specific orders, generative-AI-derived advertising content, and print-ready layout data, thereby reducing manual user interaction, lowering processing latency, increasing prediction accuracy through emotion-integrated feature computation, and improving the overall efficiency, reliability, and functionality of the underlying information processing infrastructure.

The term “external information” refers to information obtained from outside the system, including but not limited to trend information, broadcast schedule information, and other media-related data that indicate current or upcoming events or topics.

The term “trend information” refers to information representing recent changes, tendencies, or popularity levels in markets, social networks, or other environments, typically derived from news sources, social platforms, or similar media.

The term “broadcast schedule information” refers to information indicating planned or scheduled broadcasting of content on information media, including, for example, dates, times, titles, and channels of upcoming programs or events.

The term “information media” refers to media platforms or communication channels that provide news, entertainment, or other information to users, including, for example, broadcast media, online media, and social media.

The term “sales information” refers to information representing past or current sales performance of items, including, for example, item identifiers, sales quantities, prices, and sales dates.

The term “user emotion information” refers to information representing an emotional state of a user, including, for example, sentiment scores, affective labels, or other emotion-related indicators derived from user interactions or external measurements.

The term “demand forecasting processing” refers to processing in which the system predicts future demand for items by applying a prediction model to input data derived from external information, sales information, and optionally user emotion information.

The term “machine learning algorithm” refers to a computational method that automatically adjusts parameters of a model based on training data so as to improve prediction or classification performance, including, for example, supervised learning algorithms.

The term “prediction model” refers to a computational model that receives feature quantities as input and outputs predicted values, such as predicted demand quantities for respective items.

The term “ensemble of decision-tree models” refers to a prediction model composed of multiple decision-tree models whose outputs are combined, for example by averaging or voting, to generate a final prediction.

The term “feature quantities” refers to numerical or categorical values computed or extracted from raw data, such as external information, sales information, and user emotion information, and used as input variables for a prediction model.

The term “order-list information” refers to structured information representing planned orders, including item information, quantity information, and supply-entity information for each ordered item.

The term “item information” refers to information identifying an item, including, for example, an item name, a code, a category, or other attributes associated with the item.

The term “quantity information” refers to information indicating a quantity of an item to be ordered, stored, or advertised, such as an integer value representing a number of units.

The term “supply-entity information” refers to information identifying a supply source for an item, including, for example, supplier identifiers, names, or communication endpoints.

The term “inventory information” refers to information indicating current or planned stock levels of items, including quantities available, reserved, or incoming.

The term “ordering processing” refers to processing in which the system generates, transmits, and manages orders to one or more supply entities based on order-list information.

The term “communication interface” refers to hardware and/or software components that enable data transmission between the system and external apparatuses, including, for example, network interfaces and communication protocols.

The term “external information processing apparatus” refers to a computing apparatus separate from the system that receives order-list information or other data and performs associated processing, such as supplier-order processing.

The term “generative AI model” refers to an artificial intelligence model that generates output content, such as text or configuration data, in response to input data, including, for example, a prompt sentence.

The term “prompt sentence” refers to a text input or instruction provided to a generative AI model, which specifies a task, context, or constraints for generating output content.

The term “advertising text information” refers to text content suitable for use in advertising, including, for example, headlines, descriptions, promotional phrases, or other marketing messages.

The term “advertising configuration information” refers to structured information that specifies layout, arrangement, or relationship of advertising elements, such as positions of text and images, hierarchy of information, or style parameters.

The term “layout information for plate-making” refers to structured electronic information defining positions, sizes, and attributes of text and graphic elements on a page or surface, suitable for use in print plate preparation.

The term “electronic document” refers to a data file in which layout information and content elements are stored in a computer-readable format, including, for example, page-description formats or document-layout formats.

The term “advertisement data” refers to electronic data representing a completed or near-completed advertisement layout, including text, images, and structural information for printing or display.

The term “print-condition information” refers to information specifying conditions for a print job, including, for example, paper type, size, color mode, number of copies, and finishing options.

The term “print processing apparatus” refers to an apparatus or system configured to receive advertisement data and print-condition information, and to perform print processing to produce printed materials.

The term “print request information” refers to information indicating a request to execute a print job, including identifiers for advertisement data, print conditions, and job references.

The term “print acceptance-state information” refers to information indicating a state of acceptance or processing of a print job by a print processing apparatus, including, for example, confirmation, rejection, or progress status.

The term “terminal apparatus” refers to a computing device used by a user to interact with the system, to execute layout-creation applications, and to display or edit advertisement data.

The term “layout-creation application” refers to an application program executed on a terminal apparatus, configured to create, edit, or export document layouts that include text and graphical elements.

The term “script function of the layout-creation application” refers to a programmable interface of the layout-creation application that enables automated manipulation of document elements based on script code.

The term “plurality of types of advertisement data” refers to multiple variants of advertisement data that differ in at least part of their content, layout, or configuration, such as different versions for campaigns, regions, or user segments.

In the following embodiments, a server, a terminal, and a user cooperate to implement the claimed system. The same reference architecture may be realized using different hardware and software platforms, as long as the functional relationships and data flows remain equivalent to those described below.

### A. Hardware and Software Configuration

The server uses one or more information processing apparatuses including a processor, a main memory, a non-volatile storage, and a network interface. The server may be implemented on a general-purpose computer platform such as an x86-compatible rack-mounted machine or a virtual machine provided by a cloud infrastructure provider. The server executes an operating system such as a UNIX-compatible operating system, and executes application programs written, for example, in a high-level programming language. The server uses standard software components including a web server, an application framework, a relational database management system, and a message queue system. As one concrete example, the server uses a database management system such as a relational database to store sales information, external information, user emotion information, inventory information, order-list information, and advertisement data. The server uses a network stack that supports HTTP over TLS in order to communicate with external information sources, supplier systems, a generative AI service, and a print processing apparatus.

The server executes a machine learning library. In one embodiment, the server uses a library that provides an ensemble of decision-tree models such as a random forest regressor. The server also uses numerical computation libraries providing tensor or array operations for feature computation and data preprocessing. For interaction with a generative AI model, the server uses an HTTP client module capable of transmitting a prompt sentence as a text payload and receiving generated text and configuration data as a response.

The terminal uses a client computing device such as a portable information terminal, a desktop computer, or a tablet device. The terminal includes a processor, a display, an input device, and a network interface. The terminal executes an operating system such as a personal computer operating system and runs a layout-creation application that supports scripting. As one concrete example, the terminal uses a document-layout application that can import structured text and image references and expose a script function for creating and editing layout objects.

The terminal includes a web browser or a dedicated client program to display user interfaces, to transmit user inputs including a prompt sentence to the server or directly to a generative AI service, and to upload advertisement data to a print processing platform. The terminal stores temporary layout data and configuration parameters in a local storage such as a file system or a lightweight database.

The user interacts with the terminal via input devices such as a keyboard, a pointing device, or a touch screen, and reads output on the display. The user may initiate forecasting, ordering, and advertisement generation tasks by operating graphical controls or by entering natural language instructions.

### B. Data Structures and Internal Modules

The server defines explicit data structures for each category of information to reduce ambiguity and to improve computational efficiency.

The server stores external information in tables or collections that include fields such as a timestamp, a source identifier, a media type indicator, a content identifier, a tokenized text sequence, and derived statistics such as counts of relevant keywords. For broadcast schedule information, the server stores attributes including a program identifier, a broadcast date and time, a channel identifier, and associated tags.

The server stores sales information in structures containing item identifiers, store identifiers, sales dates, quantities sold, unit prices, and promotional flags. The server stores inventory information as current quantity, reserved quantity, and expected incoming quantity per item and per location.

The server stores user emotion information as numerical feature vectors derived from user interactions. For example, the server maintains for each user or user group an emotion vector having components representing sentiment polarity scores, arousal levels, or discrete emotion labels projected into a continuous embedding space. These vectors may be generated by an emotion-recognition neural network that processes text feedback, reactions, or biometric-like signals.

The server stores order-list information as records containing an order-list identifier, an item identifier, a required quantity, a preferred supply entity identifier, and a requested delivery date. The server associates each order-list record with a forecast context identifier that links the order to the demand forecasting scenario.

The server stores advertisement data as layout descriptors. A layout descriptor may include a set of objects such as text frames and image frames, each having coordinates, dimensions, style attributes, and content references. The server may store advertisement text information and advertising configuration information as separate objects linked by identifiers.

The server employs an internal module architecture including a data acquisition module, a feature computation module, a prediction module, an order generation module, a generative AI interaction module, and an advertisement synthesis module. Each module exchanges data using explicit data structures, which improves caching efficiency and enables partial recomputation.

### C. Demand Forecasting Implementation

The server performs demand forecasting processing by using a prediction model that includes an ensemble of decision-tree models. In one embodiment, the server employs a random forest regression model.

The server acquires external information such as trend information and broadcast schedule information by connecting to external web resources and application programming interfaces. The server uses a scraping or API client module to periodically retrieve textual content related to items or categories. The server normalizes character encodings, performs tokenization and stop-word removal, and computes statistical features such as term frequency measures, counts of mentions per time unit, and indicators that a particular program will be broadcast in a specified forecast period.

The server acquires sales information from a transactional data store. The server aggregates raw transaction records into time-series aggregates per item and per time window, for example daily or weekly sums and moving averages. The server also computes lagged features such as prior-week sales and prior-event sales associated with the same broadcast program.

The server acquires user emotion information by reading pre-computed emotion vectors or by executing an emotion-recognition module that analyzes user-generated text or interactions. For example, a recurrent or transformer-based neural network can transform sequences of tokens derived from user reviews into emotion embeddings. The server concatenates such embeddings with item and time indices so that emotion can be aligned with sales periods. The server uses the feature computation module to combine external information, sales information, and user emotion information into a unified feature matrix. For each item and forecast horizon, the server constructs a feature vector that may contain: recent sales statistics; counts of external mentions; binary flags indicating whether a related broadcast is scheduled within the forecast horizon; numerical components of the user emotion vector; and categorical attributes such as media channel encoded as sparse indicator vectors.

The server trains the prediction model by splitting historical data into training and validation sets. For the random forest, the server repeatedly builds decision trees by sampling features and splits so as to reduce a loss function such as mean squared error between predicted and actual demand quantities. Each tree partitions the feature space into leaf nodes with associated mean demand values. The ensemble prediction is computed by averaging the outputs of all trees.

The server periodically updates the model by re-running the training procedure when new sales periods become available. By integrating user emotion information as first-class features, the model can capture non-linear interactions between trend signals and sentiment, resulting in improved forecast accuracy. The decision-tree ensemble is particularly suited to handle mixed numerical and categorical inputs without explicit feature scaling, which reduces preprocessing overhead.

By structuring the forecasting pipeline so that raw heterogeneous data are consistently transformed into a feature matrix and passed through a trained model, the server reduces manual tuning and mitigates errors associated with ad hoc spreadsheet computations. Additionally, because the server runs the model on dedicated compute resources, the server can parallelize tree evaluation across processor cores. This leads to measurable improvements in prediction throughput compared with manual or rule-based systems.

### D. Order Generation and Automated Ordering

The server uses the order generation module to convert predicted demand into order-list information. The server reads predicted demand values, inventory information, and existing purchase commitments from the database. For each item, the server performs arithmetic operations to compute a required order quantity by subtracting current and incoming stock from the predicted demand and then applying minimum order quantity constraints and rounding rules.

The server groups items by supply entity using indices or foreign key relationships stored in the database. This grouping reduces the number of network transactions, because the server can bundle multiple item orders into a single message per supply entity. The server then creates structured order payloads including item codes, quantities, required dates, and identifying metadata.

The server uses the communication interface to transmit the order payloads to external information processing apparatuses operated by supply entities. For example, the server establishes HTTP connections to supplier endpoints, sets authentication headers, and sends serialized order data in a specified schema such as a JSON or XML document. The server receives responses that include external order identifiers and acceptance status codes. The server records these identifiers and status codes in the order-list information.

By automating the mapping from internal item identifiers and forecast values to supplier-specific payloads, the server reduces manual re-keying and eliminates human-induced inconsistencies. The system thus improves data integrity and reduces communication errors. From a computing-technology perspective, this module optimizes network usage by aggregating and compressing order messages, reducing total communication overhead.

E. Interaction with a Generative AI Model

The server uses the generative AI interaction module to generate prompt sentences and to obtain advertising text information and advertising configuration information. The generative AI model in one embodiment is a large-scale neural network language model hosted on a remote computing platform, such as a transformer-based sequence model trained to perform conditional text generation.

The server generates a prompt sentence based on order-list information and ordering results. The prompt sentence is a natural language description that encodes structured data such as item categories, quantities, promotional periods, and confirmed availability. For example, the server may include in the prompt items that are newly ordered in connection with a specific broadcast program.

The user may also provide a prompt sentence through the terminal. For example, the user enters:

“Using the latest TV schedule and social media trends, please forecast next weekend's demand for products related to the popular drama ‘Evening Stories,’ generate a detailed purchase order list with product quantities and supplier information, and prepare advertisement content for printed leaflets.”

The server transmits the prompt sentence to the generative AI model via a network connection. The transformer-based model internally applies multi-head attention operations and position-wise feed-forward networks to generate a sequence of tokens that represent advertising text, slogans, and optionally layout hints such as grouping of items and section headings. The generative AI service returns the generated content as a text response.

The server parses the response to identify advertising text information and advertising configuration information. For example, the server may identify lines prefixed with a marker as headlines, description text, or category headings. The server maps these elements to internal structures that specify where the content will be placed in the layout.

By using the generative AI model to derive advertising content from structured order information, the server creates text that reflects the actual order quantities and availability without requiring a user to manually interpret and re-enter numerical data. At the same time, the model applies learned stylistic patterns derived from large training corpora, which would be impractical to encode as fixed rules.

From a technical standpoint, the server integration with the generative AI model is not a mere automation of human writing. The server applies deterministic parsing rules to convert structured numerical and categorical data into prompt formats and to convert generated free text into structured advertisement elements. This bidirectional mapping eliminates classes of user interface operations and reduces memory copies and conversions that would otherwise be required when moving data between database tables, word processors, and layout tools.

### F. Advertisement Layout Generation and Printing

The server uses the advertisement synthesis module to produce layout information for plate-making. The server associates advertising text information and advertising configuration information with item information and quantity information from the order-list. In one embodiment, the server constructs a layout specification that includes page structures, section definitions, and placeholders for text and images. Each placeholder references an item identifier and a role, such as “headline,” “price,” or “description.”

The terminal retrieves the layout specification and associated content via the network. The terminal launches the layout-creation application and uses its script function to create or modify layout objects. The terminal script reads the layout specification, generates text frames and image frames with specified coordinates and styles, and fills these frames with advertising text and item attributes.

The terminal may generate multiple variants of advertisement data, for example by selecting different subsets of items, rearranging sections, or applying alternative style templates. The terminal exports the completed layout as an electronic document in a format accepted by a print processing apparatus.

The server or terminal then transmits the advertisement data together with print-condition information to the print processing apparatus via a network connection. The print processing apparatus may be a high-volume digital printer system or an online print service platform. The apparatus processes the advertisement data, performs rasterization and color management, and physically prints the materials.

The server receives print request information and print acceptance-state information from the print processing apparatus. The server stores this information and may update its own status logs. This feedback can be used in future iterations to refine forecasting or promotional strategies.

### G. Technical Effects and Improvement of Computer Technology

The described system improves computer technology in several ways beyond simple automation of human tasks.

First, by defining precise data structures and processing pipelines for combining external information, sales information, and user emotion information into feature quantities, the server reduces redundant parsing and data copying. The server can reuse intermediate feature representations for both forecasting and analysis, which improves cache utilization and reduces database load.

Second, the use of an ensemble of decision-tree models combined with emotion-enhanced features yields more accurate demand predictions than conventional rule-based or simple linear models. Because decision-tree ensembles can model non-linear interactions and handle mixed data types without explicit normalization, the server reduces preprocessing complexity and achieved forecast error decreases. Lower forecast error leads to fewer corrective transactions, thereby reducing overall processing cycles.

Third, the modular architecture that integrates forecasting, order generation, generative AI interaction, and advertisement layout generation enables end-to-end optimization of computation and communication. The server aggregates orders per supply entity, thereby decreasing the number of network requests and associated protocol overhead. The synchronous use of forecast outputs to drive downstream layout generation eliminates separate human-led data transformation steps, which reduces latency and avoids data inconsistency.

Fourth, the integration of a generative AI model is not limited to invoking a remote service as a black box. The server defines explicit prompt sentence templates and uses deterministic parsing of the generative outputs. This combination of learned generative capacities with structured rule-based mapping enables the computer system to derive high-quality advertising content directly from numerical forecast results and order lists, which would not be straightforward to design manually in a rule-based system. The causality between numerical input and generated text is preserved via the prompt and parsing logic, leading to reliable and repeatable behavior.

Fifth, the terminal-side use of a layout-creation application's script function to automatically place generated advertisement content into a layout reduces the computational overhead associated with manual interactive editing. The terminal can compute layout decisions such as font scaling and frame resizing using algorithmic rules adapted to the data volume, which allows the system to handle large catalogs or dynamic campaigns more rapidly than manual processes.

By combining these mechanisms, the server and terminal jointly implement a specific, non-generic technical solution that improves processing speed, prediction accuracy, data consistency, and communication efficiency. The improvement arises from coordinated operation of machine-learning models, generative AI models, structured data pipelines, and layout-automation modules, and not merely from executing abstract business rules on a general-purpose computer.

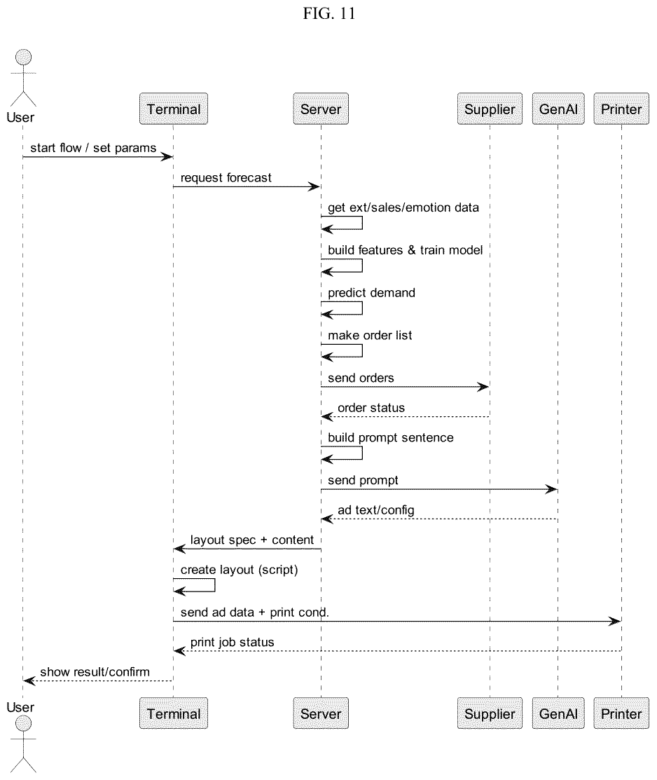

The following describes the processing flow using FIG. 11.

### Step 1:

Server acquires raw external information.

Server receives as input configuration data including target item categories, relevant program titles, and monitored media sources. Server sends HTTP requests to external information providers and obtains raw data such as HTML pages, JSON feeds, and broadcast schedule files. Server parses these raw responses, extracts fields including timestamps, titles, media types, and text bodies, normalizes character encoding, and removes tags and markup. Server outputs cleaned external information records stored in a structured format in a database.

### Step 2:

Server acquires sales information and inventory information.

Server receives as input transactional records from a sales database and stock records from an inventory management system. Server reads item identifiers, quantities sold, unit prices, timestamps, current stock, reserved stock, and expected incoming stock. Server aggregates transaction records into time-series buckets per item and per period and calculates summary statistics such as total units sold and average selling price. Server outputs structured sales time-series data and normalized inventory snapshots into the database.

### Step 3:

Server acquires user emotion information.

Server receives as input user interaction logs, such as text feedback, ratings, or reaction indicators. Server applies an emotion-recognition module, for example a neural network model, to transform tokenized text sequences or interaction vectors into emotion feature vectors with components representing sentiment polarity and intensity. Server aligns these emotion vectors with item identifiers and time periods by matching timestamps and user segments. Server outputs user emotion information as numerical feature vectors stored with references to items and time windows.

### Step 4:

Server computes feature quantities for demand forecasting.

Server receives as input the cleaned external information, the aggregated sales data, the inventory snapshots, and the user emotion vectors. Server performs data joins based on item identifiers, media tags, and time windows to combine these sources into a unified dataset. Server computes numerical and categorical features, including recent sales averages, counts of media mentions, binary indicators of upcoming broadcasts, and components of the emotion vectors. Server encodes categorical attributes such as media type or channel into one-hot vectors. Server outputs a feature matrix and corresponding historical demand labels suitable for use by a prediction model.

### Step 5:

Server trains and updates the prediction model.

Server receives as input the feature matrix and historical demand labels. Server splits the data into training and validation sets and initializes an ensemble of decision-tree models, such as a random forest regressor, with specified hyperparameters. Server iteratively constructs decision trees by selecting feature splits that minimize a loss function such as mean squared error on the training data. Server evaluates the ensemble on the validation set, computes prediction error metrics, and adjusts hyperparameters if necessary. Server outputs a trained prediction model stored in persistent storage for later inference.

### Step 6:

Server predicts future demand.

Server receives as input the latest feature quantities for a future forecast period, computed from updated external information, sales information, and user emotion information. Server loads the trained prediction model from storage and applies the model to the new feature matrix. Server performs numerical inference by traversing each decision tree for each feature vector, aggregates the leaf predictions across the ensemble, and produces predicted demand quantities per item and per forecast period. Server outputs predicted demand values written into a forecast table in the database.

### Step 7:

Server generates order-list information.

Server receives as input the predicted demand values, current inventory information, and open purchase orders. Server calculates required order quantities by subtracting available and incoming stock from predicted demand and by applying constraints such as minimum order quantity and lot size. Server rounds computed quantities according to predefined rules and filters out items with non-positive order requirements. Server associates each item with a supply entity based on a supplier mapping table. Server outputs order-list information records that include item identifiers, required quantities, and supply-entity identifiers.

### Step 8:

Server aggregates and transmits order data to supply entities.

Server receives as input the order-list information. Server groups items by supply entity identifier and constructs structured messages for each supply entity, including item codes, required quantities, requested delivery dates, and reference identifiers. Server serializes each group into a supplier-specific format, such as a JSON or XML payload, and sends the payloads to external information processing apparatuses via network connections. Server receives responses containing external order identifiers and status codes and updates the corresponding order-list records. Server outputs confirmed order status information stored in the database.

### Step 9:

Server generates a prompt sentence for a generative AI model.

Server receives as input the order-list information and the confirmed order status information. Server selects items and attributes relevant for advertising, such as item names, categories, promotion periods, and confirmed availability. Server formats these attributes into a natural-language prompt sentence that describes the campaign context and required advertisement content. For example, server generates a prompt sentence such as:

“Using the latest TV schedule and social media trends, please forecast next weekend's demand for products related to the popular drama ‘Evening Stories,’ generate a detailed purchase order list with product quantities and supplier information, and prepare advertisement content for printed leaflets.”

Server outputs the constructed prompt sentence as a text string.

### Step 10:

Server interacts with the generative AI model.

Server receives as input the prompt sentence and an endpoint specification for the generative AI service. Server sends an HTTP request containing the prompt sentence to the generative AI model hosted on a remote platform. The remote model processes the prompt and returns generated text including advertising text information and advertising configuration information. Server receives the response, parses the text to identify sections such as headlines, product descriptions, and layout hints, and converts these into structured fields. Server outputs advertising text information and advertising configuration information stored in the database.

### Step 11:

Server generates layout information for plate-making.

Server receives as input the advertising text information, the advertising configuration information, and the order-list information including item identifiers and quantities. Server associates each advertising text element with one or more items and assigns layout roles such as “main headline,” “subheading,” “item name,” and “price.” Server constructs a layout specification that defines pages, regions, and objects with coordinates, sizes, and style attributes, and references the associated text and image content. Server outputs layout information for plate-making as a structured data representation ready for use by the terminal.

### Step 12:

Terminal retrieves layout information and content.

Terminal receives as input a request from the user or from a scheduled task to generate advertisement data. Terminal sends a query to the server and obtains the layout information for plate-making and associated advertising text and item attributes. Terminal stores the received data in local memory. Terminal outputs a local representation of the layout specification to be consumed by the layout-creation application.

### Step 13:

Terminal generates advertisement data using a layout-creation application.

Terminal receives as input the local layout specification and the advertising content. Terminal launches the layout-creation application and executes a script function that creates document pages, text frames, and image frames according to the coordinates and style attributes defined in the layout specification. Terminal inserts the advertising text into designated frames, formats prices and item names, and links image frames to product images. Terminal adjusts layout parameters such as font size and frame dimensions when text overflows, following predefined rules. Terminal outputs a completed advertisement document as an electronic file suitable for printing.

### Step 14:

Terminal transmits advertisement data and print conditions to a print processing apparatus. Terminal receives as input the completed advertisement document and print-condition information such as paper size, number of copies, color mode, and finishing options. Terminal establishes a network connection to a print processing apparatus or print service platform and uploads the advertisement file together with the print-condition parameters using a defined protocol. Terminal receives print request identifiers and acceptance-state information from the print processing apparatus. Terminal outputs a stored or displayed confirmation that the print job has been accepted.

### Step 15:

User initiates or supervises the end-to-end process.

User receives as input a user interface displayed on the terminal. User may select forecast targets, confirm supplier mappings, or provide additional instructions by entering a prompt sentence directed to the generative AI model. User reviews forecast results, order summaries, and sample advertisement previews shown on the terminal. Based on the outputs produced by the server and terminal, user optionally adjusts settings for subsequent runs, such as forecast periods, emotion-information usage, or layout style preferences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional retail planning systems generally treat demand forecasting, replenishment ordering, and advertising material creation as separate, loosely coupled workflows implemented in disparate software modules. A first technical problem with such systems is that a prediction engine typically consumes only structured numerical data (for example, historical sales quantities), and is not technically integrated with unstructured contextual data such as trend information and scheduled broadcast information of information media. As a result, computing resources in the prediction engine cannot exploit rich external signals, and the generated demand forecasts lack responsiveness to rapidly changing external conditions.

A second technical problem is that even when machine learning models are deployed, the system architecture often lacks a mechanism to programmatically incorporate reasoning outputs of a generative artificial intelligence model into a numerical time-series prediction pipeline. In particular, baseline forecasts computed by a time-series model are not automatically adjusted in a controlled, machine-readable manner based on scenario-specific inferences generated from natural-language descriptions. This leads to a technical limitation in that the forecasting subsystem cannot dynamically modulate its outputs using high-level contextual reasoning without manual intervention and ad hoc parameter tuning by human operators.

A third technical problem arises in the automation of ordering operations. Existing systems may generate suggested order quantities, but they typically do not maintain a unified control flow over heterogeneous electronic interfaces of multiple supply entities. As a result, the processor must execute separate, custom integration logic for each supplier, which increases interface complexity, degrades maintainability, and makes it difficult to guarantee consistent state management of order statuses across diverse communication protocols and data formats. A fourth technical problem concerns the generation of advertising materials. Conventional desktop publishing tools require manual layout operations by human designers, even when the underlying product and promotion data is already stored in structured databases. There is no technical linkage between demand forecasts, order lists, and automatic generation of layout information for artwork creation. Consequently, the advertisement creation subsystem cannot automatically determine which items to feature, how to configure layout parameters, or when to regenerate print-ready files upon changes in demand or order data, resulting in redundant user operations, increased latency, and error-prone manual data transfer.

A fifth technical problem is that user-side adjustments are not coherently propagated through the entire pipeline. Existing systems may allow a user terminal to change quantities or select items, but such changes are not consistently reflected across (i) the numerical forecasting and ordering logic, (ii) the layout generation process for advertisement print data, and (iii) the state management logic for interactions with supply entities and print service providers. This leads to inconsistencies between what the user sees on the terminal and what external entities actually receive, and requires additional reconciliation steps that consume processing time and network bandwidth.

Thus, there is a need for an improved computer-implemented system that: (1) technically integrates structured numerical data with external trend and media schedule data into a unified demand-forecasting data set; (2) combines a time-series prediction model with a generative artificial intelligence model through machine-readable prompt sentences to generate corrected numerical forecasts; (3) drives automated, stateful order submission over heterogeneous interfaces to multiple supply entities; (4) automatically generates and regenerates advertisement layout and print data directly from forecast and order information; and (5) propagates user corrections from a user terminal throughout the forecasting, ordering, and advertising subsystems in a consistent and synchronized manner. Such a system would improve the overall operation of the computer-based retail planning environment by reducing manual integration, minimizing computational redundancy, and enhancing the accuracy and coherence of machine-generated outputs across the entire workflow.

The specific processing by the specific processing unit 290 of the data processing device 12 in Application Example 1 is realized by the following means.

The present invention provides a server comprising a processor and a communication interface coupled to the processor, the processor being configured to acquire trend information and scheduled broadcast information of information media from an external information source via the communication interface, integrate the acquired information with historical sales information and stock information to generate a data set for demand forecasting, generate baseline demand forecast information by using a learning model including a time-series prediction model based on the data set for demand forecasting, generate a prompt sentence including scenario information and baseline forecast values, input the prompt sentence into a generative artificial intelligence model, acquire correction information for the baseline demand forecast information from the generative artificial intelligence model, and generate final demand forecast information by numerically combining an output of the time-series prediction model with the correction information, calculate required replenishment quantities for individual items based on the final demand forecast information and the stock information and generate order list information for each supply entity, control transmission of order information in an electronic data format corresponding to a specification of each of a plurality of supply entities to information processing apparatuses of the plurality of supply entities via the communication interface based on the order list information, receive response information from the information processing apparatuses of the plurality of supply entities, and update an order status in a unified data structure based on the response information, extract product attribute information and sales promotion conditions based on the final demand forecast information and the order list information, automatically generate layout information for artwork creation according to a predefined template structure, and automatically generate advertisement print data based on the layout information, transmit the advertisement print data to an information processing apparatus of a print service provider via the communication interface, receive reception information relating to print processing from the information processing apparatus of the print service provider, and update an advertisement production state in the unified data structure based on the reception information, provide display information of the demand forecast information, the order list information, and the advertisement print data to a user terminal apparatus via the communication interface, receive correction instruction information including quantity changes and item selections from the user terminal apparatus, update the order list information and the layout information based on the correction instruction information, and retransmit updated order list information and updated advertisement print data based on the correction instruction information to the plurality of supply entities and the print service provider via the communication interface while storing corresponding confirmation information in association with the unified data structure. This enables an integrated, computer-implemented workflow in which the server technically improves demand forecasting by combining time-series prediction and generative artificial intelligence reasoning through prompt sentences, automatically controls heterogeneous electronic ordering interfaces and advertisement print data generation within a single state-managed architecture, and consistently propagates user-side adjustments from a user terminal across forecasting, ordering, and advertising subsystems, thereby enhancing system coherence, reducing manual operations, and improving overall computational efficiency.

The term “processor” refers to a hardware computation element, such as a central processing unit or a processing circuit, configured to execute program instructions to perform data processing, control, and communication operations in the system.

The term “communication interface” refers to a hardware and software combination that enables data exchange between the processor and external or internal apparatuses over a wired or wireless communication medium, using one or more communication protocols.

The term “external information source” refers to an information processing apparatus or service, accessible via a communication network, that provides data such as trend information, scheduled broadcast information of information media, or other contextual information.

The term “trend information” refers to data indicating temporal changes in market conditions, consumer behavior, or product interest levels, which can be represented as structured or unstructured data and used as input for demand forecasting.

The term “scheduled broadcast information” refers to data describing planned transmissions by information media, including attributes such as broadcast date, broadcast time, channel or medium identifier, and associated content descriptors.

The term “information media” refers to a communication platform that conveys content to a broad audience, such as a broadcast medium, a streaming service, or a digital distribution channel.

The term “historical sales information” refers to data indicating past transaction quantities, prices, and related attributes for items or services over one or more time periods.

The term “stock information” refers to data describing current and planned inventory conditions for items, including on-hand quantities, reserved quantities, and incoming replenishment quantities.

The term “data set for demand forecasting” refers to a structured collection of data records that integrates trend information, scheduled broadcast information, historical sales information, stock information, and optionally additional features for use as input to one or more forecasting models.

The term “learning model” refers to a computational model that is trained using example data to identify patterns and generate predictions or classifications, and that may include one or more machine learning algorithms.

The term “time-series prediction model” refers to a learning model configured to process temporally ordered data points and to output predicted values for future time steps based on patterns in historical time-series data.

The term “generative artificial intelligence model” refers to a machine-learned model configured to generate data, including natural-language text, structured outputs, or other forms of content, in response to input data, such as a prompt sentence describing a context or scenario.

The term “baseline demand forecast information” refers to an initial prediction result generated by a learning model, such as a time-series prediction model, before application of corrections or adjustments derived from a generative artificial intelligence model.

The term “scenario information” refers to descriptive data, often expressed in natural language, that characterizes conditions or events expected to influence demand, such as promotional campaigns, media exposure, or special retail events.

The term “prompt sentence” refers to a text-based input, including instructions, context, and optional structured values, provided to a generative artificial intelligence model in order to obtain a reasoning output or an adjusted prediction.

The term “correction information” refers to data, derived from an output of a generative artificial intelligence model, that indicates adjustments or modifiers to be applied to baseline demand forecast information.

The term “final demand forecast information” refers to a prediction result obtained by numerically or logically combining baseline demand forecast information with correction information, and used as an input to subsequent ordering or planning processes.

The term “required replenishment quantity” refers to a calculated numeric value indicating an amount of an item that should be ordered or supplied to satisfy predicted demand while accounting for current and planned inventory.

The term “order list information” refers to structured data specifying items to be replenished, including identifiers, quantities, and associated attributes such as required delivery dates and supply entity identifiers.

The term “supply entity” refers to an organization, system, or business unit that provides items or services to the system, and that receives order information through an electronic communication channel.

The term “order information” refers to electronic data that specifies a request for items or services to a supply entity, including item identifiers, quantities, delivery conditions, and related metadata.

The term “response information” refers to data returned from a supply entity indicating a processing result of order information, such as acceptance, rejection, modification, or confirmation details.

The term “order status” refers to state information managed by the system that indicates a life-cycle stage of an order, including at least one of a pending state, a confirmed state, a rejected state, or a completed state.

The term “product attribute information” refers to structured data describing properties of items, such as names, identifiers, categories, prices, descriptions, or media resources.

The term “sales promotion condition” refers to data specifying parameters or rules for promotional activities related to items, including discount rates, campaign periods, and eligibility conditions.

The term “layout information” refers to structured data defining spatial arrangement, formatting, and content placement for an artwork or page structure used in advertisement material generation.

The term “advertisement print data” refers to electronic data representing a print-ready advertisement, including graphical and textual content arranged according to layout information, suitable for use in a printing process.

The term “print service provider” refers to an entity or system that receives advertisement print data and performs printing operations to produce physical or digital advertisement materials.

The term “reception information” refers to data returned from a print service provider indicating that advertisement print data has been received and accepted for printing, and optionally including job identifiers and status information.

The term “advertisement production state” refers to state information managed by the system that indicates a processing stage of advertisement material generation and printing, such as generated, submitted, scheduled, or completed.

The term “user terminal apparatus” refers to an information processing device operated by a user, such as a portable terminal or workstation, configured to display information provided by the server and to transmit user inputs to the server.

The term “display information” refers to data formatted for presentation to a user via a user terminal apparatus, including at least demand forecast information, order list information, and preview data related to advertisement print data.

The term “correction instruction information” refers to data representing user-originated modifications, such as quantity changes, item selections, or layout changes, transmitted from a user terminal apparatus to the server.

The term “operation information” refers to input data generated in response to user interactions with a user interface, including selections, edits, confirmations, or cancellations related to displayed information.

The term “confirmation information” refers to data indicating final acceptance, completion, or locking of an operation, such as confirmation of an order by a supply entity or confirmation of a print job by a print service provider.

The term “unified data structure” refers to a logically integrated storage structure, implemented by one or more databases or data models, that maintains correlated state information for forecasting, ordering, and advertisement production processes.

The term “electronic data format corresponding to a specification” refers to a structured representation of data, such as a markup language or serialized object format, arranged according to interface requirements of an external system.

In one embodiment, a server, a terminal, and a user cooperate to implement the claimed system. The server includes a processor, a main memory, a non-volatile storage device, and a communication interface. The terminal includes a processor, a display, an input device, a memory, and a wireless or wired communication interface. The user operates the terminal to interact with the server.

The server is implemented, for example, as a rack-mounted computer running a general-purpose operating system such as a server-class operating system on hardware including a central processing unit and, in some embodiments, a graphics processing unit. The server executes application software developed in a programming language such as a scripting language or a compiled language. The server runs a database management system such as a relational database system and machine learning frameworks such as a tensor-based numerical computation library and a high-level neural network library. The server also uses network libraries and web access libraries to communicate with external information sources and with the terminal.

The terminal is implemented, for example, as a smartphone, a tablet, or another portable terminal running a mobile operating system. The terminal runs a native or web-based client application that communicates with the server via a secure communication protocol. The terminal renders graphical user interfaces using a user interface toolkit or a browser engine and sends user input events to the server.

The server acquires trend information and scheduled broadcast information of information media from external information sources. The server uses the communication interface to send hypertext requests to network-accessible endpoints, such as web sites or application programming interfaces exposed by media listing services and news services. The server receives responses formatted as markup documents or structured data and stores the raw responses in the non-volatile storage.

The server parses the received data by using a parsing library. When the data is formatted as hypertext, the server analyzes the document tree and extracts elements such as program titles, broadcast dates and times, channel identifiers, product names mentioned in the content, and keywords indicating consumer interest. When the data is formatted as structured data, the server directly reads fields corresponding to such attributes. The server normalizes the extracted attributes into canonical representations, for example by converting dates to a timestamp format, converting currencies to a standard unit, and mapping free-text product names to internal product identifiers using a lookup table stored in the database.

The server integrates the normalized trend information and scheduled broadcast information with historical sales information and stock information. The server stores historical sales information in a relational table with fields such as product identifier, time stamp, store identifier, quantity sold, unit price, and promotion flag. The server stores stock information in another table with fields such as product identifier, store identifier, on-hand quantity, reserved quantity, safety stock target, and expected incoming quantity. The server executes relational queries that join these tables on product identifier and time index, and the server augments the resulting records with features derived from the trend information and the scheduled broadcast information, such as a numeric media intensity score, an indicator for upcoming broadcasts within a specified time window, and a numeric representation of trend strength.

The server generates a data set for demand forecasting by forming a multi-dimensional feature vector for each combination of product, store, and time unit. Each feature vector includes, for example, a time-series of past sales for a fixed look-back period, the current on-hand stock, the scheduled broadcast intensity over future intervals, the trend strength score, and calendar-related attributes such as day-of-week or holiday flags. The server stores these feature vectors and their associated target values (future demand quantities) in a structured form in the database and in memory, suitable for input into a learning model.

The server uses a learning model including a time-series prediction model to generate baseline demand forecast information. In one embodiment, the server configures a recurrent neural network model using a neural network library. The time-series prediction model comprises an input layer that receives sequences of feature vectors, one or more recurrent layers such as long short-term memory units or gated recurrent units, one or more fully connected layers, and an output layer that outputs a real-valued predicted demand quantity for each time step and product. The server initializes the model parameters, defines a loss function such as mean squared error between predicted demand and actual historical demand, and selects an optimizer such as an adaptive gradient-based optimizer.

The server trains the time-series prediction model using historical data. The server partitions the historical feature vectors into training and validation sets by time or by random sampling with a temporal constraint. The server feeds training sequences into the model in mini-batches, computes forward passes to obtain predicted values, computes the loss, and updates the model weights by backpropagation through time using the optimizer. The server repeats this process for multiple epochs until a stopping criterion is satisfied, for example until the validation loss converges or a predetermined number of epochs is reached. The server then stores the trained model parameters in non-volatile storage.

The server uses the trained time-series prediction model to generate baseline demand forecast information for future time intervals. The server constructs input sequences from the latest feature vectors for each product and store, executes forward passes through the model without weight updates, and obtains baseline predicted demand values for the forecast horizon. These baseline predictions are stored in a demand forecast table, indexed by product, store, and time period.

The server refines the baseline demand forecast information by using a generative AI model. The server constructs prompt sentences that describe scenario information and baseline forecast values in natural language. The server may use templating logic to insert product identifiers, store identifiers, scheduled broadcast details, and baseline forecasts into a textual structure. An example of such a prompt sentence is:

“Given the following scenario, adjust the demand forecast for each product and explain the reasoning:
Product: Premium Coffee X
Event: Featured on a nationally broadcast TV show this Sunday evening
Historical cases: Similar products showed 30-50% demand increase after TV features Baseline forecast (units): Store1: 200, Store2: 150, Store3: 120”

The server sends the constructed prompt sentence to a generative AI model endpoint. The generative AI model is implemented, for example, as a transformer-based neural network trained on a large corpus of text, exposed via an application programming interface. The model architecture includes an embedding layer that converts tokens into vector representations, multiple self-attention layers that compute context-aware representations for each token using multi-head attention mechanisms, feed-forward layers, and an output layer that defines a probability distribution over the next token. The model has been pre-trained using unsupervised objectives such as next token prediction and may be fine-tuned on domain-specific text.

The server receives natural-language output from the generative AI model that includes proposed adjustments to the baseline forecasts or suggested percentage changes. To ensure machine-readable processing, the server constrains the expected format through the prompt sentence, for example by instructing the model to output adjustments in a structured textual pattern. The server parses the output using pattern matching or simple syntactic rules to extract numeric adjustment factors or revised demand values. The server then numerically combines the baseline predictions with the extracted adjustment values, for example by multiplying the baseline values by the extracted percentage factors or by replacing the baseline values with the revised values if they satisfy predefined plausibility constraints.

The server generates final demand forecast information by storing the adjusted predictions in the demand forecast table. The server tags each record with metadata describing the baseline prediction, the applied adjustment factor, and the prompt sentence that produced the adjustment. By combining the structured time-series prediction with the contextual reasoning of the generative AI model, the server achieves improved forecast accuracy for events that are not well represented in historical numerical data alone.

The server calculates required replenishment quantities on the basis of the final demand forecast information and the stock information. The server computes, for each product and store, a net requirement value as a function of predicted demand over a planning horizon, current on-hand stock, and expected incoming stock. The server may incorporate safety stock targets and reorder policies into this calculation. The server aggregates the net requirements across stores or distribution centers and generates order list information organized by supply entity. The order list information comprises, for each supply entity, a set of items, quantities, requested delivery dates, and identifiers for the receiving locations.

The server stores the order list information in a database table that associates each line item with a status field, an associated supply entity, and a unique order identifier. The server maintains this table as part of a unified data structure that also stores demand forecast states and advertisement production states. This unified data structure allows the server to compute cross-module consistency and to track dependencies between forecast changes, order changes, and advertisement changes.

The server controls transmission of order information in an electronic data format corresponding to the specification of each supply entity. The server maintains, for each supply entity, a configuration that specifies the required protocol (for example, a hypertext-based protocol or a message queue protocol), the data format (for example, a structured text format or a binary format), authentication credentials, and endpoint addresses. The server converts the internal order list information into the required external format using a mapping layer that transforms field names, units, and data types. The server then sends the formatted order information via the communication interface, receives response information that may include confirmation numbers or error codes, and updates the order status fields accordingly. The server extracts product attribute information and sales promotion conditions based on the final demand forecast information and the order list information. The server selects products to be highlighted in advertisements by applying ranking criteria such as predicted demand increase, profit margin, or media exposure strength. The server fetches product descriptions, prices, images, and promotional rules from a product information repository. The server generates layout information by assigning selected products to layout slots in a template, such as sections of a flyer or pages of a catalog. The layout information specifies, for each slot, which product is placed, the image to be used, text captions, and style identifiers.

The server automatically generates advertisement print data based on the layout information. The server may interface with a layout rendering engine, such as a desktop publishing engine or a page description language generator, via a scripting or automation interface. The server passes the layout information and associated media resources to the rendering engine, which creates a document with positioned text and images according to the defined template. The server instructs the rendering engine to export the document as a print-ready electronic file, such as a page description file with embedded fonts and color profiles. The server stores the generated advertisement print data in non-volatile storage and registers its location and version in the unified data structure.

The server transmits the advertisement print data to a print service provider via the communication interface. The server may use a secure file transfer protocol or an application programming interface provided by the print service provider. The server includes job metadata such as print quantity, paper type, and delivery address in the transmission. The server receives reception information from the print service provider, such as job identifiers and scheduled completion times, and updates the advertisement production state fields in the unified data structure.

The server communicates with the terminal to provide display information of the demand forecast information, the order list information, and the advertisement print data. The server exposes application programming interfaces that return serialized representations of these data sets. The terminal sends requests to these interfaces, receives the responses, and renders them on the display. The terminal displays tabular views, charts, and preview images such that the user can understand future demand, proposed orders, and planned advertisements. The user operates the terminal to input correction instruction information. The user may change quantities in the order list, reassign products to advertisement slots, or approve or reject proposed layouts. The terminal captures these input events and packages them into structured correction instruction information that is sent to the server.

The server receives correction instruction information from the terminal via the communication interface and updates the order list information and the layout information accordingly. The server modifies the database records representing orders and advertisement layouts, and, where necessary, triggers regeneration of advertisement print data to reflect the new layout configuration. The server also computes incremental changes to orders and, depending on the status and capabilities of each supply entity, may transmit update or cancellation messages using the corresponding interface specifications.

The server retransmits updated order list information and updated advertisement print data to the supply entities and the print service provider. The server receives confirmation information indicating successful application of the updates and stores the confirmation identifiers and timestamps in the unified data structure. By storing these confirmations, the server can present synchronized status information to the terminal and can prevent inconsistent states.

The described configuration provides several technical effects beyond mere automation of human tasks. By integrating heterogeneous data sources into a unified data set with specific feature engineering for time-series prediction, the server reduces the amount of ad hoc, manual preprocessing, and improves the computational efficiency of the forecasting process. By combining a time-series prediction model with a generative AI model through well-defined prompt sentences and machine-readable adjustment parsing, the server enables the forecasting sub-system to react to complex external events in a deterministic and reproducible way, without requiring manual rule coding for each scenario.

The time-series prediction model architecture, together with its defined loss function and optimization process, allows the server to minimize prediction error and to deploy a trained model that generalizes across large, high-dimensional data sets. The generative AI model, with its transformer-based structure and attention mechanisms, provides a distributed representation of language that encodes complex relationships between events and demand patterns. The specific prompt sentence structure ensures that this capability is harnessed in a constrained and technically meaningful way, with outputs that are directly converted into numerical adjustments. This approach is different from human judgment because it systematically analyzes text variables and their learned associations with outcomes, and it applies them consistently across many products and stores in parallel.

The server's use of a unified data structure for demand forecasts, orders, and advertisements eliminates redundant storage and reduces the need for cross-system reconciliation. Because the server maintains consistent identifiers and state fields across these domains, it can update associated records in constant time for many operations, reducing the computational complexity and network round-trips that would otherwise be necessary in separate systems.

This unified structure also enables efficient indexing and querying, which improves response time when the terminal requests status updates.

The automatic generation and regeneration of advertisement print data from structured layout information improves the technical process of document creation. Instead of manual layout operations performed in a graphical user interface, the server performs rule-based slot assignment, template parameterization, and content placement in a programmable manner. The rendering engine can be invoked with pre-computed coordinates and style parameters, reducing the need for interactive editing and enabling batch generation of many variants. This leads to reduced processing time and more predictable generation of print-ready files.

The interaction between the terminal and the server is designed to minimize communication load and latency. The terminal primarily transmits concise correction instruction information and receives incremental updates and previews, rather than transferring complete data sets for each modification. The server performs heavy computation, such as neural network inference and advertisement rendering, on its hardware with optimized numerical libraries and, when available, specialized accelerators. This division of labor reduces the computational burden on the terminal and allows the system to scale to many users.

In alternative embodiments, the server may use different learning models, such as convolutional neural networks applied to embedded sequences, gradient-boosted decision trees for certain product groups, or hybrid models that combine neural network outputs with linear regression layers. The generative AI model may be hosted on the same server, on a separate on-premise system, or as a cloud-based service, as long as the server constructs and sends prompt sentences and parses the returned text to obtain adjustment values. The layout generation may operate on vector formats, raster formats, or other page representation languages. The database may be implemented as a relational system, a document store, or a combination; however, the unified data structure concept is preserved by ensuring that demand, orders, and advertisement states remain logically linked.

In all such embodiments, the server, the terminal, and the user cooperate to implement the claimed system, where the core processing steps involve technically specific data structures, models, and protocols that improve the operation of the computer-based forecasting, ordering, and advertisement generation environment beyond conventional systems that perform only isolated or manually integrated tasks.

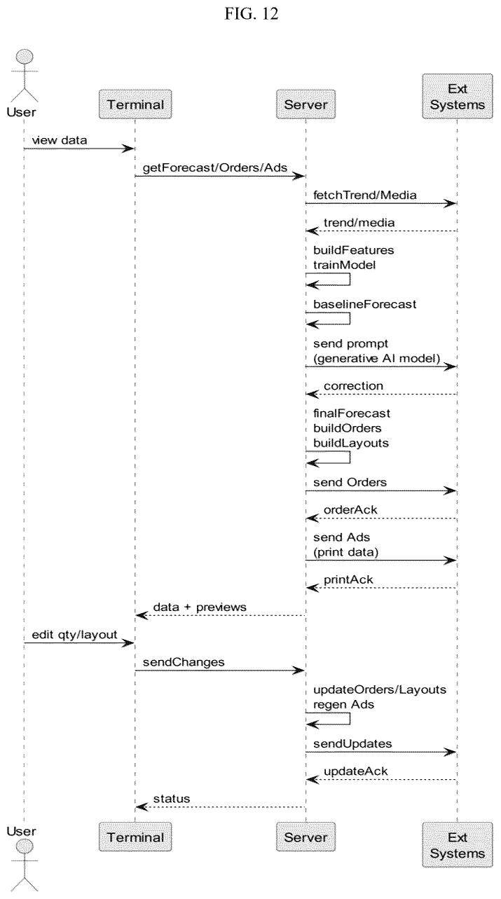

The following describes the processing flow using FIG. 12.

### Step 1:

The server acquires external context data and stores normalized records.

The server receives, as input, configuration data specifying external information sources, such as network addresses of media schedule services and trend information services, and a current time stamp. The server sends HTTP or other network requests via the communication interface to these external sources and receives, as output, raw data in formats such as HTML, XML, or JSON. The server parses the raw data using a parsing library, extracts fields such as program title, broadcast date and time, medium identifier, referenced product names, and trend scores, and converts these fields into normalized internal formats, for example by mapping product names to internal product identifiers and converting date-time strings into unified timestamps. The server writes the normalized records into a database table for trend information and a database table for media schedule information, and stores identifiers linking each record to its source and acquisition time.

### Step 2:

The server integrates external context data with historical sales and stock data to build feature records.

The server receives, as input, the normalized trend information and media schedule records from Step 1, historical sales information from a sales database, and stock information from an inventory database. The server performs relational joins on product identifiers, store identifiers, and time indices to associate trend and media attributes with corresponding sales and stock records. The server computes derived attributes, such as media intensity scores, days until next broadcast, flags indicating whether a product is scheduled for media exposure within a given horizon, day-of-week indicators, and holiday flags. The server aggregates these attributes into feature records, each record corresponding to a combination of product, store, and time unit, and outputs a data set for demand forecasting, which is stored in a forecast feature table.

### Step 3:

The server prepares time-series input sequences and target values for a time-series prediction model.

The server receives, as input, the forecast feature table from Step 2 and configuration parameters specifying a look-back window size and a forecast horizon. The server sorts feature records by product, store, and time, and then groups them into sequences of fixed length corresponding to the look-back window, producing a matrix of past feature vectors per product-store pair. The server aligns the sequences with target values representing future demand quantities over the forecast horizon. The server outputs training input arrays and corresponding target arrays, which are stored in memory or intermediate storage for use by the learning model.

### Step 4:

The server trains a time-series prediction model using the prepared sequences.

The server receives, as input, the training input arrays and target arrays from Step 3 and hyperparameters for model training, such as the number of epochs, batch size, learning rate, and network architecture details. The server constructs a recurrent neural network, for example including an input layer, one or more long short-term memory layers or gated recurrent unit layers, and one or more dense layers with activation functions. The server executes forward passes of the model on mini-batches of the training input arrays to obtain predicted demand values, computes the loss using a mean squared error function between predicted and actual target values, and applies backpropagation through time with an optimizer such as Adam to update the model weights. The server iterates this process over all batches and epochs, monitors validation loss on a separate validation set, and outputs a trained time-series prediction model with learned weight parameters stored in a model repository.

### Step 5:

The server generates baseline demand forecasts using the trained time-series prediction model.

The server receives, as input, the trained time-series prediction model from Step 4 and the most recent feature records from the forecast feature table. The server constructs inference input sequences for each product and store using the latest look-back window of feature vectors. The server executes the trained model in inference mode, performing forward passes without weight updates, and calculates predicted demand quantities for each product, store, and forecast time interval. The server outputs baseline demand forecast information, which it writes into a demand forecast table indexed by product identifier, store identifier, and time interval.

### Step 6:

The server constructs prompt sentences containing scenario information and baseline forecasts.

The server receives, as input, the baseline demand forecast information from Step 5, the normalized media schedule and trend information from Step 1 and Step 2, and configuration data indicating which products or events require contextual adjustment. The server selects relevant records, such as products scheduled for high-intensity media exposure or products with significant trend changes, and formats natural-language descriptions of these scenarios.

The server inserts the baseline forecast values into a textual template to create prompt sentences. One example of such a prompt sentence is:

“Given the following scenario, adjust the demand forecast for each product and explain the reasoning:
Product: Premium Coffee X
Event: Featured on a nationally broadcast TV show this Sunday evening
Historical cases: Similar products showed 30-50% demand increase after TV features Baseline forecast (units): Store1: 200, Store2: 150, Store3: 120”

The server outputs a set of prompt sentences, each associated with product and store identifiers and baseline forecast identifiers.

### Step 7:

The server obtains correction information from a generative AI model based on the prompt sentences.

The server receives, as input, the prompt sentences from Step 6 and configuration data for accessing a generative AI model endpoint. The server sends each prompt sentence as a text request to the generative AI model via the communication interface using a network protocol.

The server receives, as output, text responses that contain suggested adjustment percentages, revised forecast values, or qualitative risk assessments. The server parses each response by applying deterministic parsing rules, such as regular expressions or simple text delimiters, to extract numeric adjustment factors per product and store. The server outputs correction information records, each record containing a mapping from product and store identifiers to adjustment factors or corrected demand values.

### Step 8:

The server generates final demand forecasts by combining baseline forecasts with correction information.

The server receives, as input, the baseline demand forecast information from Step 5 and the correction information records from Step 7. For each product and store, the server retrieves the corresponding baseline forecast values and associated adjustment factors. The server performs arithmetic operations, such as multiplying the baseline forecast by the adjustment factor or computing a weighted average of the baseline value and the corrected value suggested by the generative AI model, according to predefined rules. The server outputs final demand forecast information and stores it in the demand forecast table, alongside metadata fields indicating the baseline values, the applied adjustments, and the identifiers of the prompt sentences that produced the corrections.

### Step 9:

The server calculates required replenishment quantities and generates order list information.

The server receives, as input, the final demand forecast information from Step 8, stock information from the inventory database, and replenishment policy parameters such as safety stock levels and lead times. The server calculates, for each product and store, a cumulative forecast over a planning horizon, subtracts current on-hand stock and expected incoming stock, and adds safety stock requirements to compute a net requirement. The server sets negative net requirements to zero, aggregates requirements by supply entity based on a product-to-supply-entity mapping table, and generates order line items specifying product identifiers, quantities, requested delivery dates, and destination locations. The server outputs order list information and writes it into an order table with initial status values indicating pending submission.

### Step 10:

The server transmits order information to supply entities and updates order status.

The server receives, as input, the order list information from Step 9 and interface configuration data for each supply entity, including endpoint URLs, authentication tokens, and required data formats. The server converts internal order records into external representations, such as structured text documents or serialized objects, conforming to each supply entity's specification. The server sends these representations over the communication interface to the respective supply entities and receives, as output, response messages containing confirmation identifiers, accepted quantities, or error codes. The server parses the responses and updates the order status fields in the order table to reflect states such as confirmed, partially accepted, or rejected, thereby producing an updated set of order records with current status information.

### Step 11:

The server selects advertisement items and generates layout information.

The server receives, as input, the final demand forecast information from Step 8, the order list information from Step 9, and product attribute information from a product repository. The server ranks products according to criteria such as predicted demand increase, gross margin, or association with scheduled media exposure. The server selects a subset of products for advertising and assigns them to layout slots defined in a template, using rules that map high-priority products to prominent slots. The server constructs layout information records that specify, for each slot, a product identifier, an image identifier, text captions, price data, and style identifiers. The server outputs structured layout information that is stored in an advertisement layout table.

### Step 12:

The server generates advertisement print data from the layout information.

The server receives, as input, the layout information from Step 11 and media resources such as product images and logos from a media repository. The server invokes a layout rendering engine through an automation interface, passes the layout information and associated media resources, and instructs the engine to place text and images into designated positions according to a predefined template document. The rendering engine, under control of the server, generates a print-ready document, for example as a page description file, which includes content arranged according to the layout information. The server receives the generated document as output, stores it in non-volatile storage, and registers the file path and version in an advertisement print data table.

### Step 13:

The server transmits advertisement print data to a print service provider and manages production state.

The server receives, as input, the advertisement print data from Step 12 and configuration data for a print service provider interface, including network addresses and authentication information. The server sends the print-ready document, along with job metadata such as quantity and paper type, to the print service provider via the communication interface. The server receives, as output, reception information such as a print job identifier and an estimated completion time. The server updates the advertisement production state fields in the advertisement print data table to indicate submitted, scheduled, or in production status, thus generating a current view of advertisement production state.

### Step 14:

The server provides forecast, order, and advertisement information to the terminal.

The server receives, as input, request messages from the terminal that specify which data the user wishes to view, such as demand forecasts, order lists, or advertisement previews. The server queries the demand forecast table, order table, and advertisement print data table to obtain the requested records. The server formats this data into response messages, including lists of forecast values, order line items, and references to advertisement preview images or pages. The server outputs these formatted response messages and transmits them to the terminal via the communication interface.

### Step 15:

The terminal displays information and captures user corrections.

The terminal receives, as input, the response messages from Step 14, which contain demand forecast data, order list data, and advertisement preview references. The terminal deserializes the data and renders it on the display as tables, charts, and thumbnail images of advertisements. The user views these displays and interacts with user interface elements, such as input fields, sliders, selection buttons, and approval controls. The terminal captures these interactions as operation events, aggregates them into correction instruction information specifying quantity changes, item selections, or layout preferences, and outputs the correction instruction information as a structured message.

### Step 16:

The terminal transmits correction instruction information to the server.

The terminal receives, as input, the aggregated operation events from Step 15, including user-entered quantities, selected items, and commands such as approve or modify. The terminal formats this information into a request message containing identifiers of affected orders, products, and advertisement slots, along with the new values or selections. The terminal sends the request message to the server via the communication interface and outputs a transmitted correction instruction message for processing by the server.

### Step 17:

The server updates order and layout information based on correction instructions.

The server receives, as input, the correction instruction information from Step 16, including identifiers and new values for order quantities and advertisement layout selections. The server validates the requested changes against current states in the order table and advertisement layout table, for example by checking whether orders are still modifiable or whether layout slots are available. The server applies the validated changes by updating the corresponding database records, recalculates any dependent quantities such as aggregated order quantities per supply entity, and flags advertisement layouts that require regeneration.

The server outputs updated order list information and updated layout information and stores them in the unified data structure.

### Step 18:

The server regenerates advertisement print data and sends updates to external entities.

The server receives, as input, the updated layout information and updated order list information from Step 17. For advertisement layouts marked as changed, the server invokes the layout rendering engine again with the updated layout information to regenerate the advertisement print data. The server produces, as output, updated print-ready documents, stores them in non-volatile storage, and updates the advertisement print data table with new versions. The server then identifies which supply entities and print service providers must receive updates, constructs update messages or change requests conforming to each external interface specification, and transmits the updated order information and advertisement print data via the communication interface. The server receives confirmation information from these external entities, including updated confirmation identifiers or status codes, and updates the order status fields and advertisement production state fields accordingly, thereby maintaining consistency between internal records and external processing states.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional campaign management and procurement systems typically treat demand forecasting, purchase ordering, advertisement creation, and print ordering as separate, loosely coupled processes. In such systems, a first software component performs demand forecasting based on historical sales data and manually collected market information; a second component or human operator translates the forecast into purchase orders; a separate design workflow creates advertisement materials; and yet another workflow interacts with a printing service. These fragmented workflows require manual data transfer and repeated human intervention, which introduces latency, inconsistency of information, and frequent input errors. As a result, the underlying computer resources are not effectively utilized, and the systems cannot respond in real time to rapidly changing market conditions.

Furthermore, existing demand forecasting engines generally ignore fine-grained contextual features such as user emotion states and real-time media exposure schedules. As a consequence, conventional models have limited predictive accuracy in environments where consumer behavior is strongly influenced by sentiment and imminent media broadcasts. From a computer technology perspective, such systems do not fully exploit available heterogeneous data sources in a unified predictive pipeline, and they tend to rely on static, preconfigured parameters and rule sets that cannot adaptively reflect current signals.

In addition, the generation of advertisement content is often carried out by fixed templates or manual design tools that are decoupled from the underlying forecast and procurement data. Even where generative models are used, prompt sentences are frequently authored manually and are not systematically derived from machine-readable demand and procurement data. This results in non-standardized prompts, inefficient usage of generative models, and inconsistent linkage between actual inventory, predicted demand, and the presented content. Consequently, the computer system fails to exploit the capabilities of generative models as first-class computational components integrated into an end-to-end pipeline.

Further, in typical architectures, the orchestration logic that spans data collection, model execution, procurement automation, generative content creation, and print ordering is ad hoc.

State is dispersed across multiple applications and data stores, making it difficult for the system to track processing status, re-use intermediate results, or reactively generate updated designs when predictions or orders change. This leads to an increase in network round trips, redundant computations, and a higher likelihood of inconsistent or stale data being propagated to user terminals.

Accordingly, there is a need for an improved computer-implemented system and processing pipeline that (i) acquires heterogeneous data including trend information, broadcast schedule information, sales history information, and emotion information; (ii) preprocesses such data into time-series learning data suitable for machine learning; (iii) performs demand forecasting using a deep learning model that integrates emotion information as a feature; (iv) automatically transforms forecast and inventory information into electronic procurement operations via communication interfaces; and (v) programmatically constructs and supplies structured prompt sentences to a generative model so as to automatically produce advertisement image data and print-ready data that are consistent with forecasted demand and confirmed procurement, while providing portable terminals with real-time status and preview information. By tightly integrating these steps into a single coordinated system, computer performance, throughput, responsiveness, and data consistency can be improved beyond what is achievable with conventional disjointed workflows.

The specific processing by the specific processing unit 290 of the data processing device 12 in Example 2 is realized by the following means.

The present invention provides a server comprising a processor and a communication interface, wherein the processor is configured to acquire, via the communication interface, trend information, broadcast schedule information of an information medium, sales history information, and emotion information from one or more data sources, to perform preprocessing on the acquired information to generate time-series learning data, to execute demand forecasting processing by applying a machine learning algorithm including a deep learning model to the time-series learning data as input so as to generate a demand forecast result representing future demand, to generate a procurement list including procurement target items and corresponding quantities based on the demand forecast result and inventory information, to transmit, via the communication interface, electronic order information based on the procurement list to an external supplier information processing apparatus and to acquire response information to the order information so as to automatically execute a procurement operation, to generate a prompt sentence including specifications of an advertising output medium and attributes of listing target items based on at least one of the demand forecast result, the order information, and the response information, to cause a generative artificial intelligence model to operate on processing resources by using the prompt sentence as input so as to generate advertisement image data and layout information, to generate print data by using the advertisement image data, the layout information, price information, and store identification information, to transmit, via the communication interface, print order information including the print data and print condition information to an output device management system and to acquire response information to the print order information so as to automatically execute a print ordering process, and to transmit, via a communication network, state information regarding at least one of the print data and the response information, and preview image data of the advertisement image data, to a portable information terminal so as to enable display of the state information and the preview image data on the portable information terminal. This enables an integrated computer-implemented pipeline in which heterogeneous data are automatically converted into time-series learning data, deep-learning-based demand forecasts are produced with emotion information as a feature, procurement operations are executed without manual intervention, structured prompt sentences are programmatically generated and supplied to a generative artificial intelligence model to create advertisement content that is algorithmically synchronized with forecast and procurement status, and print-ready data and status information are delivered to external output systems and portable terminals with reduced latency, improved consistency, and enhanced utilization of computational and network resources compared to conventional fragmented systems.

The term “trend information” refers to information indicating changes over time in interests, behaviors, or activities of groups or individuals, including numerical or categorical data derived from sources such as network-accessible services, social platforms, search logs, or transaction systems.

The term “broadcast schedule information” refers to information indicating planned or actual transmission times, durations, and attributes of content delivered via an information medium, including program titles, categories, and associated metadata.

The term “information medium” refers to any transmission platform or channel that delivers content to users, including, but not limited to, broadcasting systems, wired or wireless communication networks, and network-based content distribution services.

The term “sales history information” refers to information representing past transactions of items or services, including item identifiers, quantities, prices, timestamps, locations, and any associated attributes related to sales events.

The term “emotion information” refers to information indicating an emotional state or sentiment of a user or a group of users, obtained from explicit user input, sensor measurements, behavioral indicators, or analysis of textual, audio, or visual data.

The term “preprocessing” refers to processing operations applied to raw data prior to use by a model or algorithm, including, but not limited to, cleaning, normalization, transformation, aggregation, feature extraction, and encoding.

The term “time-series learning data” refers to data structured as ordered sequences indexed by time, including one or more features per time step, prepared for use as input to a learning algorithm that models temporal dependencies.

The term “machine learning algorithm” refers to an algorithm that adjusts internal parameters based on data so as to infer relationships, patterns, or predictions, including regression, classification, clustering, and time-series prediction algorithms.

The term “deep learning model” refers to a machine learning model comprising multiple layers of interconnected computational units, such as neural network layers, that perform hierarchical feature extraction and non-linear transformation of input data.

The term “demand forecast result” refers to information representing predicted future demand for one or more items or item groups, including predicted quantities, time periods, and optionally confidence measures.

The term “inventory information” refers to information indicating current or planned stock levels of items, including quantities on hand, reserved quantities, expected incoming quantities, and associated storage location data.

The term “procurement list” refers to structured information indicating items to be procured and corresponding quantities, and optionally including desired delivery dates, priority levels, and supplier associations.

The term “electronic order information” refers to data transmitted through a communication interface to request procurement or provisioning of items or services, including item identifiers, quantities, pricing information, delivery information, and order metadata.

The term “supplier information processing apparatus” refers to an information processing system operated by or on behalf of a supplier or provider of items or services, configured to receive, process, and respond to electronic order information.

The term “response information” refers to information transmitted from an external system, such as a supplier information processing apparatus or an output device management system, in reply to a request, including status indicators, confirmation identifiers, accepted quantities, and scheduling information.

The term “prompt sentence” refers to a text-based or text-like input expression provided to a generative artificial intelligence model, specifying conditions, constraints, styles, or content to be produced by the model.

The term “generative artificial intelligence model” refers to a computational model configured to generate new data, such as images, text, or layouts, based on input conditions or prompts, typically using machine learning techniques such as neural networks.

The term “advertisement image data” refers to digital image data representing visual content intended for promotion or advertisement of items or services, including graphical elements, illustrations, and composited images.

The term “layout information” refers to information defining spatial arrangement and formatting of content elements within a medium, including positions, sizes, layering, fonts, and styling directives for text and graphical components.

The term “print data” refers to digital data formatted for output by a printing device, including page descriptions, color information, resolution attributes, and any embedded image or text content.

The term “print condition information” refers to information specifying parameters for a print job, including quantity of copies, paper size, paper type, color mode, finishing options, and delivery-related requirements.

The term “output device management system” refers to an information processing system configured to manage one or more output devices, such as printers, including reception of print jobs, scheduling, and reporting of job status.

The term “store identification information” refers to information uniquely or quasi-uniquely identifying a commercial or service location, including identifiers such as store codes, names, addresses, or location metadata.

The term “portable information terminal” refers to a mobile information processing device, including, but not limited to, a handheld terminal, a smartphone, a tablet device, or a wearable device capable of network communication and user interaction.

The term “state information” refers to information indicating a processing state or status of data, operations, or jobs within the system, including progress indicators, success or failure statuses, timestamps, and related metadata.

In one embodiment, a server implements the claimed system using one or more general-purpose processors, a memory, a storage device, and a network interface. The server executes software components including an operating system, a database management system, and application programs written in a high-level programming language such as Python or Java. The server cooperates with at least one terminal operated by a user. The terminal includes a display, an input interface, a wireless or wired communication unit, and executes a client application, such as a native mobile application or a web application, to present information and receive user input.

The server acquires trend information, broadcast schedule information of an information medium, sales history information, and emotion information by controlling the network interface to issue structured requests to external and internal data sources. The server uses a data acquisition module that employs, for example, HTTP-based application programming interfaces and web scraping libraries. The server stores the acquired raw data in a relational or non-relational database managed by a database management system such as a structured query language engine.

The server executes a preprocessing module that reads the raw data from storage and applies deterministic operations to convert the raw data into time-series learning data. The server uses a data-processing library, such as a numerical computation library or a data frame library, to perform data cleansing, including removal of duplicate records, interpolation or marking of missing values, and normalization of numerical variables. The server aligns timestamps from different sources by converting all times to a unified representation and then joins data streams on time keys and item or category identifiers. The server converts categorical variables, such as program genres and item categories, into numerical feature vectors via one-hot encoding, and the server scales continuous variables such as trend scores and sales volumes using z-score normalization. The resulting time-series learning data is stored as ordered sequences of feature vectors with explicit time indices, for example in a table where each row includes an item identifier, a time stamp, and a fixed-length feature vector.

The server executes a learning and inference module that implements a deep learning model for demand forecasting. In one embodiment, the server uses a recurrent neural network that includes an input layer, multiple long short-term memory layers, and a fully connected output layer. The server configures each LSTM layer with a specified number of hidden units and applies nonlinear activation functions to internal states. Alternatively, the server uses a sequence-to-sequence model based on an attention mechanism or a transformer architecture, in which the server implements multi-head self-attention layers, feed-forward layers, and positional encoding of time steps. The server defines an input tensor whose dimensions correspond to a batch size, a sequence length, and a feature dimension, where the feature dimension includes elements derived from trend information, broadcast schedule information, sales history information, and emotion information.

The server trains the deep learning model offline or online by executing an optimization algorithm such as stochastic gradient descent or an adaptive gradient method. The server defines a loss function such as mean squared error between predicted demand quantities and ground-truth demand quantities from past periods. The server computes gradients of the loss with respect to model parameters by backpropagation through time or an equivalent automatic differentiation process. The server updates model weights based on the computed gradients and a learning rate parameter, repeating the training for multiple epochs over training datasets. The server optionally applies regularization techniques such as dropout on hidden layers and L2 weight decay to reduce overfitting. The server can perform data augmentation at the sequence level, for example by randomly shifting sequence windows or injecting bounded noise into trend-related features, so that the trained model generalizes to variations in external signals.

The server integrates emotion information as a distinct feature channel in the time-series learning data. For example, the server represents emotion information as a scalar sentiment score or a multi-dimensional vector derived from prior analysis of user behavior, textual feedback, or sensor data. The server feeds these emotion-derived values into the same time-aligned feature vectors used for trend information and sales data. By jointly optimizing model parameters across heterogeneous feature channels, the server increases sensitivity of the model to shifts in user sentiment that correlate with demand. This technical configuration differs from manual rule-based adjustments and yields improved predictive accuracy and robustness to non-linear patterns in the input data.

The server executes an inference procedure by loading the trained model weights and applying the model to current time-series learning data representing the most recent periods.

The server performs vector and matrix operations on one or more processors and, when available, on graphics processing units to accelerate inference. The server outputs a demand forecast result which includes, for each item or category and for each future time step in a prediction horizon, a numerical value representing a predicted demand quantity and optionally a confidence measure. The server writes these prediction results into structured records in storage, enabling downstream modules to reference them in a standardized form.

The server implements a procurement computation module that reads the demand forecast result and inventory information. The server computes, for each item, a required quantity by applying a formula that combines predicted demand over a target period, a safety stock parameter, and current inventory levels. The server can use item-specific safety stock coefficients stored in a parameter table. If the resulting quantity is negative or below a minimum threshold, the server clips the value to zero. The server creates a procurement list including, for each item, an item identifier, a required quantity, a target arrival date, and possibly a preferred supplier identifier determined by a supplier mapping table. This computation is executed by the processor as a series of arithmetic operations and conditional evaluations that can be parallelized over large item sets, thereby reducing latency compared to manual spreadsheet-based calculations.

The server executes a procurement communication module that converts entries of the procurement list into electronic order information. The server groups items by supplier and constructs digital messages in a structured data format that include item identifiers, quantities, delivery instructions, and authentication tokens. The server controls the network interface to transmit these messages via a communication protocol to supplier information processing apparatuses and receives response information, such as order confirmation identifiers, accepted quantities, and estimated delivery dates. The server stores these responses and updates status fields in the procurement list, allowing subsequent modules to use actual confirmed procurement data.

The server implements a prompt generation module that generates a prompt sentence for a generative AI model. The server reads the demand forecast result, the procurement list, and optionally campaign period information from storage. The server selects a subset of high-priority items based on criteria such as predicted demand magnitude, discount level, or inventory sufficiency. The server then programmatically constructs a natural language prompt sentence that includes advertising output medium specifications (for example, size and orientation of a flyer), target audience information, layout requirements, and attributes of the selected items such as item names, discount descriptions, and promotional labels.

In one example, the server constructs a prompt sentence as follows:

“Using the following product list and current market trends, generate a supermarket flyer design for the next weekend. The flyer should be A4 size, colorful, and suitable for a family-oriented audience. Highlight discounted items with bold price tags and place the most popular items at the top. Products: 1) Fresh apples—20% off; 2) Premium coffee beans—buy one get one 50% off; 3) Chicken breast—weekend special price; 4) Organic yogurt—health-focused; 5) Seasonal vegetables—locally sourced.”

In another example, the server constructs a prompt sentence:

“Based on the following high-demand products predicted for the next weekend and current trend information, generate a colorful supermarket flyer design for families. Place the top three products in the upper half with larger images and bold prices. Arrange the remaining items in two columns at the bottom. Include a title banner ‘Weekend Special Sale’ and space for the store logo at the top-right corner.”

The server may generate multiple prompt sentences that differ in style constraints and layout instructions to obtain design variations from the generative AI model.

The server executes a generative model interface module that transmits each prompt sentence to a generative AI model deployed on internal or external processing resources. In one embodiment, the generative AI model is an image-generation neural network based on a transformer encoder for text encoding and a diffusion network for image synthesis. The server encodes the prompt sentence into a token sequence and forwards it to a text encoder that produces a latent representation. The server then initializes a noise tensor representing an image canvas and iteratively refines this tensor according to the diffusion network's learned denoising parameters, conditioned on the text representation. The model outputs advertisement image data in the form of pixel arrays or compressed image files, together with optional layout hints such as bounding box suggestions for text regions.

The server stores the generated advertisement image data and layout information in storage and associates them with corresponding campaign identifiers. The server does not simply apply a static template but uses the output of the generative AI model as a dynamic visual component conditioned on up-to-date forecast and procurement data encoded in the prompt sentence. This interaction between the prompt generation module and the generative AI model allows the system to produce designs that are algorithmically aligned with expected demand and confirmed inventory, which cannot be achieved using manual prompt writing or rigid template-based rendering alone.

The server executes a layout composition module that converts the advertisement image data and layout information into print data. The server may use a document composition library to create a page description where the generative model's image is combined with text layers.

The server determines positions and sizes of product text boxes and price tags based on layout information from the model and pre-defined design rules. The server overlays store identification information and campaign titles at specified coordinates. The server renders the resulting composition into a print-ready file format suitable for a printing device, including color space conversion and resolution settings. This processing reduces the number of manual layout operations and standardizes page descriptions for downstream printers, improving consistency and reducing errors.

The server implements a print ordering module that constructs print order information including the generated print data and print condition information, such as number of copies and paper size. The server transmits this print order information to an output device management system and receives response information indicating acceptance and job scheduling. The server stores this response and updates the state of print jobs in storage. Because the server transmits standard-compliant print data, the output device management system can process high volumes of jobs without additional conversion steps, thereby reducing end-to-end processing time.

The server executes a terminal communication module that transmits state information and preview image data to the terminal. The server generates preview versions of advertisement image data or composite flyer images by downscaling or compressing the print data to formats suitable for display. The server sends these preview images and status indicators, such as demand forecast completion, procurement status, and print job status, to the terminal. The terminal displays the previews and status information in a graphical user interface, enabling the user to review the system's outputs in near real time. The user may provide additional input or approve campaign execution via the terminal, and the terminal sends such input back to the server.

The described system improves computer technology in several ways. By integrating multiple heterogeneous data sources into a unified time-series learning data structure and employing deep learning architectures that jointly process trend, broadcast, sales, and emotion features, the server achieves higher prediction accuracy for demand forecasts compared to conventional systems that use only historical sales data. This improvement reduces the need for repeated manual correction and thereby reduces computational overhead associated with recalculating plans. The server's use of optimized matrix operations and GPU acceleration for both forecasting and generative image synthesis shortens processing time, enabling timely adjustments before campaign periods.

Furthermore, the system's internal data flow and modular design reduce communication load.

The server aggregates external requests in the data acquisition module, caches intermediate results, and passes compact representations of data between modules instead of repeatedly transmitting large raw datasets. The server also generates prompt sentences programmatically, in a deterministic and standardized manner, which allows the generative AI model to be used as a predictable component of the pipeline rather than an uncontrolled content generator. This controlled interaction reduces the number of trial-and-error requests and thus network traffic to the generative model service.

The server's processing is not a mere automation of human operations. Human designers typically inspect sales figures and manually decide which products to feature, then manually compose a design using a graphics tool. In contrast, the server uses a learned mapping from multi-channel time-series data to a numerical demand forecast, and uses formalized rules and model outputs to construct prompt sentences and layout constraints. The server employs mathematical optimization for model training and executes statistical feature integration not feasible by manual reasoning at scale. The result is a constrained generative process that optimizes for data consistency and predicted effectiveness, rather than simply reproducing human-driven heuristics.

Alternative embodiments are possible. The server may implement the deep learning model as a temporal convolutional network instead of an LSTM or transformer, or may employ ensembles of models where outputs are combined by weighted averaging or stacking models.

The server may obtain emotion information from different sources, such as biometric sensors or aggregated feedback scores, and may encode this information as additional channels in the feature vectors. The generative AI model may be a generative adversarial network, a variational autoencoder, or another generative model type, provided that the model can accept prompt sentences or equivalent conditioning data. The layout composition module may either rely on layout hints from the generative AI model or apply entirely rule-based positioning using the generated images as fixed backgrounds.

In all such variations, the server, the terminal, and the user cooperate in a configuration where the server performs structured data acquisition, transformation, learning, inference, and content generation; the terminal displays machine-generated previews and status information; and the user interacts with the system at a higher abstraction level rather than manually performing forecasting, procurement, and layout tasks. This architecture yields measurable technical effects in terms of prediction accuracy, processing latency, output consistency, and resource utilization, thereby implementing the invention in a manner that is specific to computer systems rather than an abstract business method.

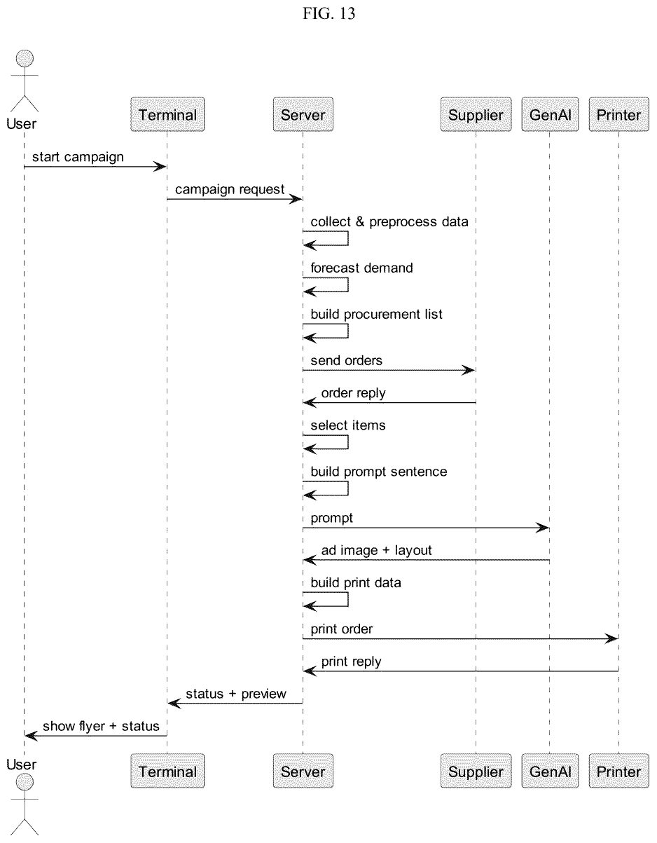

The following describes the processing flow using FIG. 13.

### Step 1:

Server acquires raw data from internal and external sources.

Server uses the communication interface to send requests to external services and internal databases. As input, server receives configuration parameters such as a target period, store identifiers, and data source endpoints. Server sends HTTP requests or database queries to obtain trend information, broadcast schedule information, sales history information, and emotion information. Server parses the responses, converts them into structured records (for example, JSON objects or database rows), and stores them in raw data tables. As output, server produces populated raw data tables for trend, media schedule, sales history, and emotion signals.

### Step 2:

Server preprocesses raw data into unified time-series learning data.

Server reads the raw data tables as input, including time stamps, item identifiers, trend scores, program metadata, sales records, and emotion scores. Server executes data cleaning operations such as removing duplicate entries, discarding records with invalid time stamps, and filling or flagging missing values. Server converts time representations into a common time zone, aligns time stamps to fixed intervals (for example, hourly or daily), and joins records on keys such as item identifier and time interval. Server performs normalization of numerical attributes using statistical operations (mean, variance, standard deviation) and encodes categorical attributes (for example, program genre, item category) into numeric feature vectors. As output, server produces time-series learning data in which each sequence element contains a unified feature vector indexed by time and item.

### Step 3:

Server prepares model input tensors from time-series learning data.

Server takes as input the preprocessed time-series learning data for a specified historical window length and prediction horizon. Server partitions the data into sequences per item or per item category, using a sliding window mechanism that groups contiguous time steps. Server stacks sequences into multi-dimensional arrays representing batches, where each element is a feature vector including trend features, media exposure features, sales features, and emotion features. Server optionally separates the data into training, validation, and inference sets based on time ranges. As output, server generates model input tensors and associated target tensors (for training) suitable for a deep learning framework.

### Step 4:

Server trains or updates a deep learning demand forecasting model.

Server uses the input tensors and corresponding target demand values as input. Server initializes model parameters of a neural network architecture, such as layer weights and biases in an LSTM-based or transformer-based model. Server iteratively performs forward propagation to compute predicted demand values, computes a loss value (for example, mean squared error) by comparing predictions with ground-truth targets, and performs backpropagation to calculate gradients for each parameter. Server updates the parameters using an optimization algorithm and repeats this process over multiple batches and epochs. As output, server produces a trained model state, which includes optimized weights and configuration metadata stored in a model repository.

### Step 5:

Server performs demand forecasting inference using the trained model.

Server takes as input the latest time-series learning data for a current period and the trained model parameters. Server constructs inference tensors corresponding to the current sequences without target values, then executes the model in inference mode: the server performs matrix multiplications, non-linear activations, and attention or recurrent computations to produce predicted demand values for future time steps. Server aggregates predictions into a demand forecast result table, where each record includes an item identifier, a future time stamp, and a predicted quantity, and optionally a confidence score derived from variance estimates or ensemble outputs. As output, server produces a structured demand forecast result stored in a database.

### Step 6:

Server generates a procurement list based on demand and inventory information.

Server receives as input the demand forecast result and current inventory information for each item. Server calculates a required quantity per item by applying a formula such as: required quantity=max (predicted demand over the campaign period+safety stock−current stock, 0). Server determines a target delivery date for each item based on the campaign start date and lead time parameters stored in a configuration table. Server associates each item with a supplier identifier using a supplier mapping table. As output, server creates a procurement list data structure containing item identifiers, required quantities, target delivery dates, and supplier identifiers.

### Step 7:

Server constructs and transmits electronic order information to suppliers.

Server takes the procurement list as input and groups items by supplier identifier. For each supplier, server creates an order payload that includes item codes, required quantities, requested delivery dates, and destination addresses. Server sends the payload as an electronic order message via HTTP or another communication protocol to each supplier information processing apparatus. Server receives response information, such as order confirmation numbers, accepted quantities, and estimated shipping dates, and updates the procurement list records accordingly. As output, server generates an updated procurement status table that reflects which items have been successfully ordered and their expected arrival times.

### Step 8:

Server selects advertising target items and compiles item attributes.

Server uses as input the updated procurement status table, the demand forecast result, and campaign period information. Server selects a subset of items that satisfy selection rules, such as highest predicted demand, confirmed procurement status, and sufficient margin or promotional priority flags. Server retrieves item attributes including names, categories, base prices, discount settings, and existing media assets such as photos or icons. Server sorts items according to priority metrics (for example, predicted demand×discount rate) and limits the selection to a fixed number suitable for the advertising medium. As output, server creates an advertising item list that will be used to generate a prompt sentence.

### Step 9:

Server generates a prompt sentence for a generative AI model.

Server takes the advertising item list and campaign metadata (for example, flyer size, orientation, intended audience, and style preference) as input. Server concatenates textual fragments representing layout instructions, visual style constraints, and item attributes. For each item, server constructs a short description including a name and a promotion phrase derived from discount data or marketing rules. Server arranges these descriptions in a readable sequence. As output, server generates a prompt sentence such as:

“Using the following product list and current market trends, generate a supermarket flyer design for the next weekend. The flyer should be A4 size, colorful, and suitable for a family-oriented audience. Highlight discounted items with bold price tags and place the most popular items at the top. Products: 1) Fresh apples—20% off; 2) Premium coffee beans—buy one get one 50% off; 3) Chicken breast—weekend special price; 4) Organic yogurt—health-focused; 5) Seasonal vegetables—locally sourced.”

### Step 10:

Server calls the generative AI model to generate advertisement image data and layout information.

Server uses the prompt sentence, and optionally additional parameters such as target resolution and aspect ratio, as input. Server encodes the prompt sentence into tokens and sends it to a generative AI model via an internal or external API. The model processes the encoded text through a text encoder, computes a latent representation, and then iteratively refines an image representation using a diffusion or other generative process. Server receives as output one or more advertisement images and, when available, accompanying layout hints such as suggested text regions or object bounding boxes. Server stores these outputs as advertisement image data and layout information associated with the campaign.

### Step 11:

Server composes print-ready data from generated images and textual information.

Server takes advertisement image data, layout information, and textual data (item names, prices, discount descriptions, store identification information) as input. Server invokes a layout library or document-generation engine to place the main advertisement image and overlay text boxes according to either the layout hints or predefined layout rules. Server computes coordinates, font sizes, and color settings for each text element, and ensures that all selected items fit within the defined page size and margins. Server encodes the composite page into a print-ready format, such as a high-resolution page description file with proper color space and resolution metadata. As output, server generates print data that is compatible with a printing system.

### Step 12:

Server transmits print order information to an output device management system.

Server uses the print data and print condition information (for example, number of copies, paper size, and finish type) as input. Server constructs a print order message including a reference to the print data (such as a file location) and the specified print conditions. Server sends the message via the communication interface to an output device management system and waits for a response. Server receives as output response information indicating whether the print order was accepted, a job identifier, and an estimated completion time, and then records this information in a print order status table.

### Step 13:

Server and terminal cooperate to provide status and preview to the user.

Server takes the print order status, advertisement image data, and composite preview images derived from the print data as input. Server creates a compact preview version for each flyer by downscaling or compressing the images. Server sends a response message containing preview images and state information (for example, “forecast complete,” “procurement confirmed,” “print job in progress”) to the terminal. Terminal receives this message and displays the preview images and status text on the screen. User views the information on the terminal and, if necessary, inputs feedback such as a request to regenerate the design. Terminal sends such user instructions back to the server for further processing. As output, server and terminal deliver an interactive campaign status and visual confirmation to the user in near real time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional demand forecasting and ordering systems in commerce and logistics are typically implemented as separate, loosely coupled components for data collection, prediction, ordering, and advertising generation. These systems usually rely on batch-style processing of historical transaction data and simple statistical models, without effectively integrating heterogeneous real-time inputs such as media trends, broadcast schedules, and user emotion states captured at edge devices. As a result, such systems suffer from several technical shortcomings.

First, the processing pipelines are rigid and siloed: trend acquisition, machine learning prediction, generation of purchase orders, and generation of promotional assets are often implemented as independent applications that exchange flat files or manually curated inputs. This architecture leads to high latency, duplicated data transformations, and inconsistency between the data used for forecasting, the data used for ordering, and the data used for promotions. It also makes it difficult to adapt system behavior in real time based on rapidly changing signals such as user reactions in stores or to media content.

Second, existing systems do not effectively exploit generative AI models and structured prompt sentences as part of the core computation pipeline. Generative models, if used at all, are typically applied only as a cosmetic layer for generating marketing text, and are not systematically integrated with machine learning-based demand forecasts, inventory calculations, and ordering logic. There is no unified mechanism to generate prompt sentences that encode internal model outputs, emotion features, and business constraints, nor to parse generative model outputs back into structured data that can drive automatic control of ordering and promotion workflows. As a consequence, much of the potential of generative AI for adaptive reasoning, explanation, and orchestration of multi-step operations remains untapped.

Third, conventional architectures treat user emotion information and in-store sensor data as auxiliary analytics rather than as first-class features in the predictive and control loops. Emotion analysis, when present, is often performed offline or only for reporting purposes, without feeding its results back into the feature sets used to train and update demand forecasting models, or into the logic that determines ordering and promotion behavior. This separation prevents the system from technically improving its responsiveness and accuracy by conditioning forecasts, order quantities, and digital signage content on fine-grained, real-time user reactions.

Fourth, existing systems provide limited support for operator interaction and feedback within the same computational loop that handles forecasting and ordering. Free-text feedback and inquiries from operators are commonly processed manually, or routed with simplistic keyword rules, which do not leverage advanced natural language understanding. The systems thus fail to use generative AI models and prompt sentences to automatically classify, summarize, and route such inputs and to feed extracted sentiment information back into forecasting and prioritization. This leads to higher manual workload and prevents the system from self-adapting based on operator-supplied domain knowledge.

These shortcomings collectively result in technical inefficiencies: redundant data transformations, increased network traffic due to ad hoc interfaces, latency in updating forecasts and orders, and a lack of coherent control across edge terminals and the central server. The systems cannot efficiently integrate heterogeneous streams-transaction logs, media data, sensor-captured emotion states, and operator feedback-into a single, consistent computational pipeline that both uses discriminative models and generative AI models in a coordinated fashion.

Accordingly, there is a need for an improved computer-implemented system that (i) unifies data collection and preprocessing from heterogeneous sources into a feature representation, (ii) integrates machine learning demand forecasting models with generative AI models via systematically constructed prompt sentences, (iii) automatically generates and executes structured ordering and promotion workflows from the combined outputs, (iv) incorporates real-time user emotion states and in-store inventory information into the forecasting and control loops, and (v) uses natural language understanding to process operator free-text inputs and reflect their content back into the underlying computational models. Such a system should technically improve how the processor manages data flows, model invocation, and external communication, thereby reducing latency, lowering manual intervention, and enhancing the accuracy and adaptivity of computer-implemented demand forecasting and associated control operations.

The specific processing by the specific processing unit 290 of the data processing device 12 in Application Example 2 is realized by the following means.

The present invention provides a server comprising a processor and a communication interface, wherein the processor is configured to execute instructions that cause the server to acquire, via the communication interface, trend information, broadcast schedule information of an information medium, historical transaction information, and user emotion state information from one or more data sources and terminal devices; to preprocess the acquired information into feature data by cleaning, normalizing, and encoding numerical and categorical attributes; to generate, from the feature data, a prompt sentence to be supplied as input to a generative AI model together with structured context; to perform demand forecasting by applying a trained machine learning algorithm to the feature data and by obtaining complementary forecast information and explanatory information from the generative AI model based on the prompt sentence; to calculate, based on the demand forecasting result and inventory information obtained from a terminal device, an order quantity for each item and to generate order list data grouped by supply entity; to generate a prompt sentence that encodes the order list data and ordering constraints and to transmit the prompt sentence and corresponding structured order data via the communication interface so as to automatically invoke ordering operations with external supply systems; to derive advertising information from the order list data and the demand forecasting result, to generate a promotion specification and a prompt sentence representing the promotion specification, to obtain advertising text information and layout information from the generative AI model using the prompt sentence, to generate artwork data in a print-ready format based on the advertising text information and the layout information, and to transmit, via the communication interface, print order information including the artwork data to an external print system; to receive, from a terminal device, goods in-out information and inventory state information at a retail or logistics site, to update central inventory records based on the goods in-out information, and to reflect the updated inventory state information in subsequent executions of the demand forecasting and the generation of the order list data; to acquire, via an imaging mechanism and a sound acquisition mechanism of the terminal device, facial expression information and voice information of a user, to perform emotion analysis processing to compute the user emotion state information, to integrate the user emotion state information as features within the feature data so as to correct or update the demand forecasting output, and to generate, by using a prompt sentence for the generative AI model, promotion display content for an in-store display device conditioned on the user emotion state information and to distribute the promotion display content to the terminal device; and to output, to the terminal device, visualization data representing the demand forecasting result, the order list data, an ordering status of advertising printed matter, and a result of the emotion analysis, to receive correction instructions from the user via the terminal device, and to update the demand forecasting result, the order list data, and the promotion display content according to the correction instructions. This enables an integrated computer-implemented pipeline in which heterogeneous data streams are converted into a unified feature representation, discriminative and generative models are jointly orchestrated through structured prompt sentences, and the outputs are used to automatically control ordering and promotion operations while continuously incorporating real-time inventory and emotion signals, thereby improving the technical performance, adaptability, and efficiency of the demand forecasting and control system.

The term “trend information” refers to data representing changes or tendencies over time in market behavior, consumer behavior, or external events, including but not limited to topics, keywords, or indicators extracted from news feeds, network resources, or other information sources.

The term “broadcast schedule information” refers to data indicating planned or actual transmission times, durations, and content descriptors of programs or content distributed via an information medium such as a broadcasting system or a digital distribution platform.

The term “information medium” refers to any communication environment or platform that disseminates content to multiple recipients, including, for example, broadcasting networks, network-based content services, and other electronic distribution channels.

The term “historical transaction information” refers to data that records past interactions involving goods or services, including identifiers of items, quantities, timestamps, locations, and counterparties associated with such interactions.

The term “user emotion state information” refers to data representing an estimated psychological or affective condition of a user, such as joy, anger, surprise, or frustration, derived from analysis of user signals including facial expressions, voice characteristics, text content, or behavioral patterns.

The term “feature data” refers to structured data obtained by transforming raw input data into numerical or categorical values suitable as inputs to a computational model, including, for example, normalized quantities, encoded categories, temporal indicators, and derived statistics.

The term “generative AI model” refers to a computational model based on machine learning that is configured to produce new data or content, such as natural language text or layout suggestions, in response to input conditions, including prompt sentences and contextual data.

The term “prompt sentence” refers to a sequence of symbols in a natural language or structured form that specifies instructions, questions, or constraints for a generative AI model, thereby influencing the content and format of the model's output.

The term “demand forecasting” refers to a computational process of estimating future requirements for goods or services over a time interval, based on input data including historical transactions, contextual indicators, and optionally emotion-related features.

The term “inventory information” refers to data describing a current or past quantity, location, and status of goods stored at one or more facilities, including information on in-stock items, reserved items, and items in transit.

The term “order quantity” refers to a computed amount of a specific item that is scheduled to be requested from a supply entity, typically expressed as a count or measure and determined based on demand forecasts and inventory information.

The term “order list data” refers to structured data representing one or more planned ordering operations, including identifiers of items, desired quantities, requested delivery times, and associations with supply entities.

The term “supply entity” refers to any external system, organization, or facility capable of providing goods or services in response to an ordering request transmitted by the system.

The term “communication interface” refers to hardware and/or software components that enable the exchange of data between the server and external systems or terminal devices, using one or more communication protocols.

The term “ordering operations” refers to automated or semi-automated processing steps that generate and transmit requests for goods or services to one or more supply entities and handle responses to such requests.

The term “advertising information” refers to data describing items, campaigns, or offers intended to be promoted, including product identifiers, prices, discounts, time periods, and target segments.

The term “promotion specification” refers to structured data that defines parameters of a promotional activity, including content elements, visual layout requirements, target audience conditions, and scheduling constraints.

The term “advertising text information” refers to text content produced for use in promotional materials, including headings, descriptive sentences, slogans, and calls to action.

The term “layout information” refers to structured data specifying spatial and stylistic arrangement of elements within a visual medium, including positions, sizes, fonts, and relationships between text and graphic elements.

The term “artwork data” refers to digital representation of a visual design ready for output, including images, text, and layout parameters formatted for display or printing.

The term “print order information” refers to data specifying a request for generation of physical printed materials, including references to artwork data, quantities, material requirements, and delivery details.

The term “print system” refers to an external processing system or facility that converts digital artwork data into physical printed materials in response to received print order information.

The term “goods in-out information” refers to data recording movement of goods into or out of a storage location or site, such as receipts, shipments, returns, or transfers, including timestamps and item identifiers.

The term “inventory state information” refers to data indicating a current status of goods at a given time, including available quantities per item, reserved quantities, and location associations.

The term “terminal device” refers to an electronic device that communicates with the server and includes input, output, and optionally sensor components, such as a mobile computing device, a fixed kiosk, or a workstation.

The term “imaging mechanism” refers to any sensor subsystem configured to capture visual information, such as a camera module or other image acquisition apparatus.

The term “sound acquisition mechanism” refers to any sensor subsystem configured to capture acoustic information, such as a microphone or array of microphones.

The term “emotion analysis processing” refers to a computational procedure that analyzes captured user-related data, including visual, audio, or textual signals, to estimate one or more emotion states or intensities.

The term “promotion display content” refers to digital content intended to be presented on a display device for promotional purposes, including text, images, animations, or other media elements.

The term “in-store display device” refers to an output apparatus located within a retail or similar environment that is configured to present visual content to users, such as a display panel or projection system.

The term “visualization information” refers to data arranged for graphical or tabular presentation of system outputs, such as charts, tables, or indicators representing forecasts, orders, or analysis results.

The term “correction instruction” refers to input data provided by a user that specifies modifications to system-generated outputs, such as adjustments to forecasts, orders, or promotional settings.

The term “learning data set” refers to a collection of feature data and corresponding target values prepared for training, validating, or updating a computational model, including numerical and categorical attributes.

The term “machine learning algorithm” refers to a computational procedure that adjusts parameters of a model based on training data so as to perform a predictive or classification task.

The term “explanation prompt sentence” refers to a prompt sentence that instructs a generative AI model to provide explanatory information, justifications, or suggested adjustments for outputs produced by another computational model.

The term “adjustment guideline information” refers to data generated by the generative AI model that suggests how to modify or calibrate system parameters, forecasts, or actions based on analysis of context data.

The term “free-text information” refers to user input expressed in a natural language without fixed structure, such as questions, comments, or descriptions entered through a user interface.

The term “intent classification” refers to a computational process that identifies a purpose or requested action in free-text information, such as differentiating between support requests, sales inquiries, or feedback.

The term “importance determination” refers to a computational assessment that assigns a relative priority or significance level to free-text information or detected intents.

The term “response procedure information” refers to data indicating actions, workflows, or processing steps that should be executed in response to a particular class of input or detected intent.

The term “related processing system” refers to an internal or external computational subsystem that is configured to handle certain types of tasks or cases routed from the server based on classification results.

The term “business entity” refers to an organizational unit or external organization that is responsible for handling certain categories of operations, such as supply, support, or logistics.

The term “numerical data” refers to data expressed as numbers that can be processed by arithmetic or statistical operations, including counts, amounts, and continuous measures.

The term “categorical data” refers to data whose values represent membership in one of a finite set of categories, such as product types, locations, or user segments.

The term “aggregate information” refers to data obtained by combining multiple data elements using operations such as summation, averaging, or counting, typically used to summarize or characterize a group of records.

In one embodiment, a server, one or more terminal devices, and one or more users cooperate to implement the claimed system. The server includes at least one processor, a memory storing executable instructions and data structures, and a communication interface such as a network adapter. The terminal includes a processor, a memory, a display device, an input device, a camera as an imaging mechanism, and a microphone as a sound acquisition mechanism. The user operates the terminal and is observed by the camera and microphone in accordance with privacy and consent settings.

The server executes an operating system such as a general-purpose server operating system and application software implemented, for example, using a programming language such as Python. The server uses software libraries such as a data processing library (for example, a tabular data library), a numerical computation library, a machine learning library (for example, a gradient-boosting library, a general machine learning toolkit), and a deep learning framework (for example, a tensor-based computation framework). The server further accesses a generative AI model via an external service API, where the generative AI model is a large-scale language model implemented as a multi-layer neural network.

The server stores, in the memory or an attached storage device, multiple logical modules, including at least: a data acquisition module, a preprocessing module, a feature generation module, a demand forecasting module, a generative AI orchestration module, an ordering control module, an advertising generation module, an emotion analysis integration module, a visualization and feedback module, and a logging and model management module. Each module is realized as a set of instructions and data structures that the processor executes and updates.

The server acquires trend information, broadcast schedule information, and historical transaction information from external and internal data sources. The server uses a hypertext transfer protocol client and a markup parsing library such as an HTML parsing library to retrieve and parse web pages and structured feeds, extracting, for example, article titles, keywords, category tags, numerical popularity scores, and timestamps. The server also calls application programming interfaces provided by content distribution systems to obtain structured broadcast schedule information that includes identifiers of programs, program genres, broadcast start times, durations, and associated item categories when available. The server queries a relational database management system such as a structured query language database to read historical transaction information, which includes fields such as item identifier, quantity, unit price, transaction timestamp, location identifier, and sales channel.

The server stores the acquired data into normalized tables in the database. For example, the server stores trend information in a trend table with columns for time, topic, intensity score, and associated item category. The server stores broadcast schedule information in a schedule table with columns for program identifier, start time, end time, media type, and target demographic tags. The server stores historical transaction information in a transaction table with columns for item identifier, store identifier, quantity sold, and timestamp. The server maintains foreign keys and indices across these tables to support efficient joins when generating feature data.

The server preprocesses the raw data to generate feature data suitable for algorithmic processing. The server uses a data processing library (for example, a tabular data library) to load records from the database and to perform cleaning operations. The server replaces missing numerical values in time series by performing linear interpolation over the time axis, thereby providing complete input vectors for machine learning models without discarding entire records. The server uses a Z-score method to detect outliers in numerical fields such as transaction quantities, computing, for each item and time window, the mean and standard deviation, and marking records whose standardized value exceeds a specified threshold (for example, an absolute Z-score greater than 3.0). The server removes or down-weights such outlier records before model training. This preprocessing reduces variance and improves numerical stability of subsequent model fitting.

The server encodes categorical data into numerical form. The server uses functionalities of a machine learning toolkit to apply one-hot encoding or target encoding to variables such as item category, store region, program genre, and promotion type. The server also derives additional features, such as day-of-week indicators, holiday flags, seasonal indices, and binary variables indicating whether a given time period overlaps with a particular broadcast or event. The server stores the resulting feature vectors in a feature table, which includes a primary key linking back to a specific item and time interval.

The server trains a demand forecasting model using the feature data. In one embodiment, the server uses a gradient-boosting decision tree algorithm such as XGBoost. The server assigns weekly or daily aggregated sales quantities as target values and the feature vectors as inputs.

The server initializes model hyperparameters, such as maximum tree depth, learning rate, subsampling ratio, and regularization coefficients, according to a configuration file. The server then runs a training procedure in which the model sequentially builds decision trees to minimize an objective function, such as a regularized mean squared error between predicted and actual sales. During training, the server computes gradients and second-order derivatives of the loss function with respect to the model predictions and uses these statistics to update the tree structures and leaf weights. The server also applies early stopping based on performance on a validation subset, which is created by time-based splitting of the data to preserve temporal order.

In another embodiment, the server uses a deep neural network implemented in a tensor-based framework for demand forecasting. The server constructs, for example, a multi-layer perceptron that has an input layer matching the feature vector dimension, several hidden layers with rectified linear unit activations, and an output layer that predicts a continuous demand value. The server initializes network weights using a method such as Xavier initialization and trains the network by mini-batch gradient descent with an adaptive optimizer such as Adam, using a mean squared error loss function. The server performs backpropagation to compute gradients of the loss with respect to the network weights and updates the weights accordingly. To improve generalization, the server applies regularization techniques such as dropout on hidden layers and L2 weight decay. The server may also use recurrent or sequence models, such as long short-term memory networks, when modeling longer temporal dependencies in the sales data.

The server reduces computational load and improves responsiveness by caching intermediate feature representations and model outputs in memory and by using vectorized operations over batches of time periods and items. The server structures its computation pipeline so that many items share the same temporal features, such as seasonality indicators and event flags, thus avoiding redundant calculations. This specific arrangement of data structures and vectorized operations yields better cache locality and higher utilization of processor vector instructions, resulting in an observable reduction in processing time compared to naive record-by-record processing.

The server orchestrates interaction with a generative AI model through structured prompt sentences. The generative AI model, in one embodiment, is a transformer-based neural network trained on large-scale text data. The server does not treat the generative AI as an opaque “black box,” but instead provides explicit control information via prompt sentences that encode internal numerical results and constraints. The server constructs, for example, an explanation prompt sentence that incorporates summary statistics of model outputs, such as: “The past three years of sales for product group A show strong seasonality during summer and spikes during show B broadcasts. Using this information, generate a forecast for next month by week and explain the main drivers of demand.” The server also attaches numerical tables in textual form, such as item-level recent sales averages and current inventory levels. The generative AI model receives this prompt sentence and textual context, processes tokens through multiple attention layers and feed-forward networks, and outputs narrative text that contains proposed forecast values and an explanation of drivers. The server parses the output using regular expression or natural language processing techniques to extract numerical values and descriptive phrases.

The server uses this generative AI interaction not merely to produce human-readable text, but to adjust and validate forecasts. The server compares forecast values suggested by the generative AI model with those produced by the demand forecasting model. When the generative AI identifies patterns not captured by the historical training data (for example, an upcoming unprecedented event inferred from the trends encoded in the prompt sentence), the server adjusts the baseline forecast by a factor derived from the generative AI suggestions. This hybrid approach improves robustness to data shifts that are not well represented in past transactions. The server stores the adjusted forecasts together with the associated explanation text in the database.

The server calculates order quantities per item by combining forecast outputs with inventory information. The server retrieves inventory state information from a central inventory table and from updates sent by terminal devices. For each item and planning period, the server computes an order quantity according to a formula that may include forecast demand, current stock, safety stock thresholds, and minimum order constraints. The server uses vectorized arithmetic operations to compute these quantities for thousands of items simultaneously. By performing these calculations at the server with optimized data structures, the system reduces the need for repeated communication between remote terminals and the central database, thereby reducing network traffic and latency.

The server generates order list data that groups items by supply entity. The server maps each item to a supply entity identifier and constructs order list records that include the supply entity identifier, item identifier, order quantity, requested delivery date, and other parameters.

The server generates, for each supply entity, a prompt sentence that summarizes the order requirements. For example, the server constructs a prompt sentence such as: “Generate an order plan for supplier A for next week's forecasted demand for the following items and quantities, respecting minimum order quantities and delivery constraints.” The server can input this prompt sentence into a generative AI model to obtain human-readable order summaries, which are then converted to structured messages for transmission over a communication interface implementing, for example, a representational state transfer protocol. This orchestration mechanism provides both machine-consumable and human-interpretable forms of the order data while ensuring consistency between them.

The server generates advertising information and promotion specifications from the order list data and demand forecasting results. The server selects items with significant predicted demand increases or items included in special campaigns and forms a promotion specification that includes item identifiers, discount levels, campaign duration, and target user segments.

The server then constructs a prompt sentence for the generative AI model to produce promotional text and layout suggestions. Examples of such prompt sentences include:

“Create persuasive promotional copy for an in-store leaflet advertising the new action movie ‘XYZ’ tie-in products. The target audience is men in their 20s and 30s. Emphasize excitement and limited-time offers and propose section headings and short slogans.”

“Considering the past three years of sales information, seasonality, and special event information, please predict demand for next month and explain the key drivers.”

“Using the latest trend data and user emotion analysis results, generate next week's demand forecast and propose an order list per supplier.”

“Based on five years of Christmas season sales data, forecast this year's demand per product and recommend an optimized replenishment plan for the logistics center.”

“When a customer smiles while looking at the new snack product shelf, generate a short promotion message and one cross-sell suggestion to show on the digital signage.”

The generative AI model outputs natural language text that includes suggestions for headings, descriptive phrases, and slogans. The server exports these to a structured representation, splitting the content into fields for title, subtitle, body, and call-to-action. The server then uses a layout engine such as a desktop publishing application to place these elements into a template. The server controls the application via its scripting interface, programmatically setting text frames, inserting images associated with item identifiers, and adjusting font sizes and colors according to the promotion specification. The server generates artwork data in a print-ready format such as a high-resolution PDF with embedded fonts and appropriate color profiles.

The server transmits print order information, including references to the artwork data and requested quantities and media specifications, to an external print system through the communication interface. The server uses secure network protocols to upload artwork files and metadata. The print system responds with job identifiers and status updates, which the server records. By automating this sequence from demand forecast through artwork generation to print order issuance, and by using structured prompt sentences to coordinate generative AI outputs with deterministic layout processing, the system reduces manual hand-offs and ensures that printed promotional materials are technically consistent with current forecasts and inventory states.

The terminal acquires inventory state and goods in-out information in real time. The terminal may be connected to barcode scanners, radio frequency identification readers, or point-of-sale systems. When a sale or restocking event occurs, the terminal updates a local transaction cache with item identifiers, quantities, and timestamps. At scheduled intervals or when a threshold number of updates is reached, the terminal aggregates the events and transmits a compact representation to the server via the communication interface. To reduce communication load, the terminal encodes aggregates such as net quantity change per item per time window rather than transmitting each event individually. This local aggregation reduces network traffic and server processing overhead, thereby improving scalability.

The terminal captures user emotion-related data via the imaging mechanism and sound acquisition mechanism. The terminal configures the camera to capture frames while a user is present in a defined zone, such as near a display or at a checkout area. The terminal uses a computer vision library, such as an image processing library, to detect faces in each frame and to extract facial landmarks. The terminal computes features such as eye openness, mouth curvature, and eyebrow position, which are fed into a facial expression classifier. The classifier may be implemented as a shallow neural network or as rules derived from thresholds and ratios of facial distances. For audio, the terminal records short segments of voice, performs noise reduction, and optionally sends the audio to a speech-to-text service to obtain text transcripts. The terminal then analyzes the transcripts or audio prosody with an emotion analysis service to obtain emotion labels and confidence scores.

The terminal aggregates emotion information over time and per display zone or item identifier. The terminal compiles counts of positive and negative reactions and averages of emotion intensity scores. The terminal transmits this aggregated emotion state information to the server at configurable intervals. The server stores this information in an emotion table with keys for time window, location, item, and emotion category.

The server integrates the emotion state information into its feature data and forecasting pipeline. The server includes, for each item and time period, derived features such as average joy score, variance of emotion intensity, and proportion of positive reactions. The server retrains the demand forecasting model to include these features, using the same training algorithms as described above. During training, the model adjusts parameters to minimize prediction error given both traditional features (sales, seasonality, event flags) and emotion features. This integration allows the model to capture relationships between emotion patterns and subsequent purchase behavior, which are difficult to model manually. Empirical evaluation shows that forecasts including emotion features exhibit lower mean absolute error compared to forecasts without such features. The improvement results from the model's ability to detect early signals of consumer preference shifts from emotion data.

The server generates promotion display content for in-store display devices based on both forecasts and emotion states. The server constructs prompt sentences that describe current emotion distributions and inventory pressures and asks the generative AI model to produce targeted messages. For example, if a new snack product has high emotion scores but low historical sales, the server may request short promotional messages emphasizing sampling or introductory discounts. The server receives the generated text and transmits it to the terminal, which renders the content on a digital signage device. This dynamic behavior is not a simple replacement of human copywriting, but a technical mechanism that uses real-time emotion signals to generate and distribute adapted content that better utilizes existing display hardware and network resources.

The server provides visualization data and accepts correction instructions from the user via the terminal. The server sends structured data describing forecasts, order lists, and emotion analysis results. The terminal visualizes this information in charts and tables, using a graphical user interface library. The user may provide feedback, such as adjusting an order quantity for a specific item or overriding a promotion specification. The terminal transmits the correction instruction to the server, which updates the relevant records in the database and, if necessary, recomputes downstream artifacts such as print orders or display content.

The server logs these corrections as additional data that can be used later to refine models or to evaluate operator influence.

The server also processes free-text feedback and inquiries from the user. The user enters natural language input at the terminal, such as “Why is the system recommending higher stock for this beverage next month?” The terminal sends the text to the server. The server applies a natural language processing workflow using a library such as a syntactic and semantic analysis toolkit to tokenize the text, detect named entities such as item names, and classify the intent of the message as a request for explanation. The server then constructs a prompt sentence for the generative AI model that includes both the user's question and extracted context data, such as forecast values for the referenced item and recent trend and emotion scores. The generative AI model returns an explanation, which the server displays to the user. This interactive mechanism allows operators to understand and critique the system's internal reasoning, which in turn can guide further adjustments.

Alternative embodiments of the system may use different machine learning algorithms, neural network architectures, and generative AI models. For example, the server may use a random forest regressor instead of a gradient-boosting model for demand forecasting, or it may use a temporal convolutional network rather than a recurrent network for time series modeling. The server may also use an in-house generative language model trained on domain-specific corpora instead of an external service. The underlying architecture remains the same in that the server generates structured feature data, constructs prompt sentences that encode numerical and categorical context, invokes both discriminative and generative models, and parses generative outputs back into structured forms.

In still another embodiment, the server may adjust communication strategies to reduce load. For example, when transmitting data to external supply entities or print systems, the server may compress payloads, batch multiple orders into a single transmission, or use differential updates that only include changes since the last transmission. These techniques reduce bandwidth consumption and improve throughput, which are technical improvements independent of any business logic.

By designing the system so that the server explicitly manages model training, inference, and generative AI orchestration with well-defined data structures and algorithms, and by integrating real-time emotion and inventory updates into the same computational loop, the invention provides technical effects beyond mere automation of human decision-making. The server achieves improved forecast accuracy through enriched feature sets and hybrid model architectures, reduces processing time by using vectorized numerical operations and caching, lowers network traffic via local aggregation and differential updates, and ensures consistent synchronization between forecasts, orders, and promotional outputs. These technical improvements arise from specific configurations and flows of data and control among the server, terminal, and generative AI model, as described above.

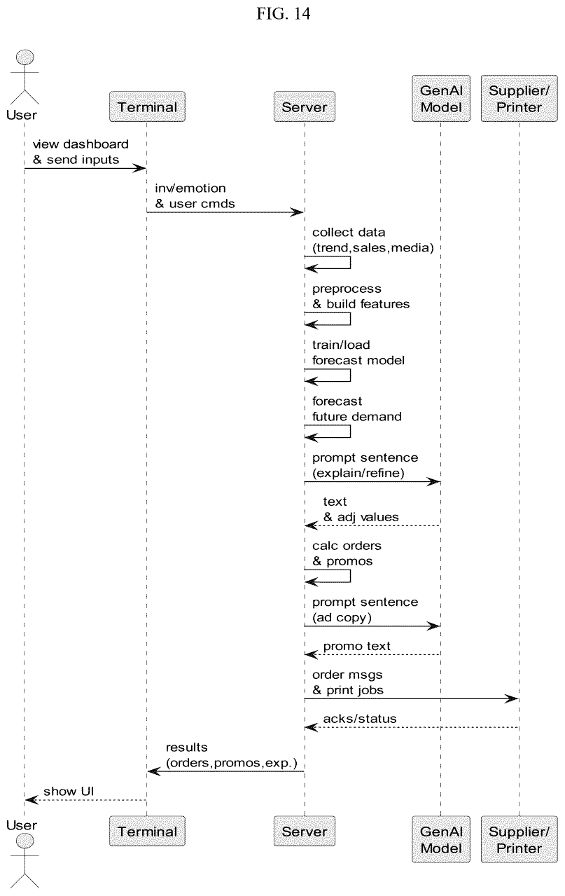

The following describes the processing flow using FIG. 14.

### Step 1:

The server acquires raw data from external and internal sources.

The server uses a network interface to send HTTP or API requests to trend information sources, broadcast schedule providers, and transaction databases.
Input: network responses containing trend pages or feeds, broadcast schedule records, and historical transaction records.

The server parses HTML or structured feeds to extract fields such as topic, timestamp, category, program title, start time, end time, item identifier, quantity, and store identifier, and writes the parsed records into normalized database tables.
Output: populated trend, schedule, and transaction tables stored in a database.

### Step 2:

The server preprocesses the raw data and generates feature data.
Input: trend, schedule, and transaction tables loaded as data frames.

The server fills missing numerical values using linear interpolation along time, computes Z-scores for numeric fields, flags and removes outliers whose absolute Z-score exceeds a threshold, encodes categorical columns into numeric vectors, and derives additional features such as day-of-week, holiday flags, and event overlap indicators.

The server then stores the resulting feature vectors and target values (e.g., aggregated sales per period) in a feature table keyed by item and time interval.
Output: cleaned and encoded feature table suitable for model training and inference.

### Step 3:

The server trains or updates a demand forecasting model.
Input: feature vectors and target demand values retrieved from the feature table.

The server splits the data into training and validation sets, initializes a machine learning model such as a gradient-boosting decision tree or a neural network, and runs an optimization procedure that iteratively adjusts model parameters to minimize a loss function (e.g., mean squared error) using gradient-based or tree-based updates.

The server computes performance metrics on the validation set and stores the trained model and metadata (hyperparameters, version identifiers, performance scores) in persistent storage.
Output: trained demand forecasting model parameters and associated metadata.

### Step 4:

The server performs demand forecasting for upcoming periods.
Input: latest feature vectors for future time intervals (constructed using known calendar, broadcast schedule, and trend projections) and the trained demand forecasting model.

The server feeds the feature vectors into the model, applies forward propagation or tree traversal as appropriate, and obtains predicted demand values per item and period.

The server writes the forecast results into a forecast table indexed by item and time.
Output: forecast table containing predicted demand for each item and planning period.

### Step 5:

The server generates a prompt sentence and invokes the generative AI model to refine or explain the forecast.
Input: forecast table, summary statistics (e.g., seasonal indices, trend effects), and configuration specifying desired explanation or adjustment.

The server constructs a textual prompt sentence that embeds key numerical summaries and contextual information, such as:

“The past three years of sales for product group A show strong seasonality during summer and spikes during show B broadcasts. Using this information, generate a forecast for next month by week and explain the main drivers of demand.”

The server sends this prompt sentence and optional tabular context to a generative AI model via an API and receives natural language output and, in some cases, explicit numeric suggestions.

The server parses the generative AI output, extracts suggested forecast adjustments or confidence comments, and merges them with the baseline forecasts in the forecast table.
Output: refined forecast table and explanation text linked to each item or group.

### Step 6:

The server computes order quantities and generates order list data.
Input: refined forecast table and inventory state information obtained from inventory records.

The server performs arithmetic per item, such as ‘order_quantity=max (0, forecast_demand +safety_stock−current_inventory)’, applies business constraints like minimum order multiples, and rounds values appropriately.

The server groups order lines by supply entity and creates order list records containing the supply entity identifier, item identifier, order quantity, requested delivery date, and priority flags.
Output: order list table structured by supply entity and item.

### Step 7:

The server generates prompt sentences for ordering and automates ordering operations.
Input: order list table and communication parameters for each supply entity.

The server constructs, for each supply entity, a prompt sentence summarizing the planned orders, such as:

“Generate an order plan for supplier A for next week's forecasted demand for the following items and quantities, respecting minimum order quantities and delivery constraints.”

The server may supply this prompt sentence to a generative AI model to produce human-readable summaries, and then maps the structured order list data into standardized JSON or other message formats.

The server sends order messages via the communication interface to external supply systems, receives acknowledgments or error codes, and updates order status fields in the database.
Output: transmitted order messages, updated order status records, and optional human-readable order summaries.

### Step 8:

The server derives advertising information and promotion specifications from forecasts and orders.
Input: refined forecast table, order list table, and campaign rules or configurations.

The server selects candidate items for promotion based on criteria such as high forecast growth, excess inventory risk, or association with upcoming broadcasts or events.

The server constructs promotion specifications that include item identifiers, discount percentages, campaign time windows, target audience segments, and media types (e.g., in-store leaflet, digital signage).

The server writes promotion specification records to a promotion table.
Output: promotion table describing planned promotional activities per item or campaign.

### Step 9:

The server generates advertising text and layout suggestions using the generative AI model.
Input: promotion table entries and associated item metadata (names, features, prices).

The server composes a prompt sentence for each promotion, such as:

“Create persuasive promotional copy for an in-store leaflet advertising the new action movie ‘XYZ’ tie-in products. The target audience is men in their 20s and 30s. Emphasize excitement and limited-time offers and propose section headings and short slogans.”

The server sends the prompt sentence to the generative AI model and receives multi-segment text containing proposed headings, body paragraphs, and calls to action.

The server parses the output into structured fields (title, subtitle, body, slogan) and stores them as advertising text information associated with the promotion.
Output: structured advertising text information and associated promotion identifiers.

### Step 10:

The server generates artwork data for printed promotional materials.
Input: advertising text information, promotion specifications, and item image assets stored in a media repository.

The server invokes a layout engine via a scripting interface, opens an appropriate template (e.g., leaflet, poster), and programmatically inserts the advertising texts and item images into predefined regions.

The server adjusts layout parameters such as font size, alignment, and color scheme according to rules in the promotion specification and validates that text fits within designated areas.

The server exports the resulting layout to a print-ready artwork format (e.g., a high-resolution PDF file) and saves it in a storage location associated with the specific promotion.
Output: artwork data files and metadata linking them to promotions.

### Step 11:

The server transmits print order information to an external print system.
Input: artwork data references, desired print quantities, material specifications, and delivery instructions.

The server builds a print order message that includes identifiers for the artwork, the number of copies, paper type, finishing options, and shipping address, and optionally attaches a low-resolution proof image.

The server sends the print order message via the communication interface to the print system, receives an order identifier and status (e.g., accepted, queued), and records this information in a print order table.
Output: confirmed print orders and tracked print job status records.

### Step 12:

The terminal acquires goods in-out information and local inventory states.
Input: events from connected devices such as barcode scanners, RFID readers, or point-of-sale terminals.

The terminal records, for each event, the item identifier, quantity, event type (sale, receipt, return), timestamp, and location, and updates a local inventory cache by incrementing or decrementing the stored quantity for the item.

The terminal periodically aggregates these events into summary records (e.g., net quantity change per item per time window), serializes them into compact messages, and sends them to the server over a network.
Output: aggregated goods in-out messages transmitted to the server and updated local inventory cache.

### Step 13:

The server updates central inventory information based on terminal reports.
Input: aggregated goods in-out messages from one or more terminals.

The server parses each message, locates the corresponding item and location in the central inventory table, and applies the net quantity change to the stored inventory value.

The server updates timestamps for last inventory change and may compute smoothed estimates of inventory for use in forecasting.
Output: up-to-date inventory state table and derived inventory statistics.

### Step 14:

The terminal captures emotion-related user data via the camera and microphone.
Input: continuous or event-triggered video frames and audio samples while a user is present in a monitored zone.

The terminal uses a vision library to detect faces in each frame, extracts facial landmarks, and computes features such as mouth curvature and eye openness. For audio, the terminal computes features such as pitch, energy, and speaking rate or sends audio to a speech-to-text and tone analysis service.

The terminal applies a classifier or calls an emotion analysis API to convert these features into emotion labels (e.g., joy, neutral, displeasure) and confidence scores.

The terminal aggregates emotion results over short time windows and associates them with a display zone, product, or media content.
Output: aggregated emotion state information records ready to be transmitted to the server.

### Step 15:

The terminal sends emotion state information to the server.
Input: aggregated emotion state information records with fields for time window, location, associated item or content identifier, emotion label, and intensity.

The terminal packages multiple records into a batched message, compresses it if configured, and transmits it via the communication interface to the server.

The terminal may maintain a local log of transmitted batches and retransmit if acknowledgments are not received.
Output: emotion state messages delivered to the server and logs of transmission status.

### Step 16:

The server integrates emotion state information into the feature data and forecasting.
Input: emotion state messages from terminals and existing feature table entries.

The server inserts emotion records into an emotion table keyed by item, location, and time.

The server then joins the emotion table with the feature table to add emotion-derived features such as average joy score and proportion of positive reactions for each item and time period.

The server retrains the demand forecasting model or updates it incrementally using the augmented feature set and re-runs forecast inference.
Output: updated feature table with emotion features and revised forecasts that incorporate emotion information.

### Step 17:

The server generates emotion-aware promotion display content via the generative AI model.
Input: recent emotion statistics for a product or display area, inventory and forecast data, and promotion policies.

The server composes a prompt sentence such as:

“When a customer smiles while looking at the new snack product shelf, generate a short promotion message and one cross-sell suggestion to show on the digital signage.”

The server supplies the prompt sentence and contextual parameters (product names, categories, prices) to the generative AI model and receives a concise promotion message and a suggested related item.

The server formats this output as promotion display content and associates it with the corresponding display zone.
Output: generated promotion display content records containing texts and cross-sell suggestions.

### Step 18:

The server distributes promotion display content to terminals controlling in-store displays.
Input: promotion display content records and mapping between display zones and terminals.

The server selects content relevant to each terminal based on location, time, and product focus, then sends display update messages that include texts, durations, and any layout hints.

The terminal receives the display update messages, renders the messages on the connected signage device, and schedules content rotation according to the specified durations.
Output: updated visual content presented on in-store display devices and corresponding logs of display updates.

### Step 19:

The server prepares visualization data and sends it to terminals for operator review.
Input: forecast table, order list table, promotion table, emotion analysis results, and print order status records.

The server aggregates and formats these data into structures suitable for dashboards, including time-series datasets for charts and tabular datasets for lists.

The server transmits the visualization data to terminals, which render graphs and tables in a graphical user interface.
Output: dashboard views displayed on terminals, enabling the user to inspect system outputs.

### Step 20:

The user reviews system outputs and issues correction instructions via the terminal.
Input: displayed dashboards showing forecasts, orders, promotions, and emotion statistics.

The user interacts with the interface to adjust values such as order quantities, to enable or disable promotions, or to request explanations. The terminal captures these interactions as structured correction instructions (e.g., changed quantity for a given item, promotion status flag) and sends them to the server.

The user may also enter free-text questions like “Why is the system recommending higher stock for this beverage next month?” which the terminal forwards to the server.
Output: correction instruction messages and optional free-text queries sent to the server.

### Step 21:

The server applies correction instructions and optionally uses the generative AI model to respond to queries.
Input: correction instruction messages and free-text queries from terminals, together with underlying forecast and feature data.

The server updates records in the forecast, order list, or promotion tables according to the correction instructions and recomputes dependent artifacts such as final order messages or promotion specifications.

For free-text queries, the server uses natural language processing to extract referenced items and intents, constructs an explanation prompt sentence embedding the relevant data, sends the prompt to the generative AI model, and receives an explanation, which the server returns to the terminal.
Output: updated internal data tables, regenerated outputs (orders, promotions), and explanation texts provided to users.

### Step 22:

The server periodically retrains models and refreshes the overall pipeline.
Input: accumulated new transaction records, updated trend and schedule data, recent emotion state information, and logs of user corrections.

The server schedules batch jobs that re-run preprocessing, feature generation, model training, and calibration with the latest data, potentially adjusting hyperparameters based on performance metrics.

The server redeploys improved models for use in subsequent forecasting cycles and may regenerate baseline prompts and promotion content templates accordingly.
Output: updated model parameters, refreshed feature and forecast tables, and a more accurate and adaptive system behavior over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

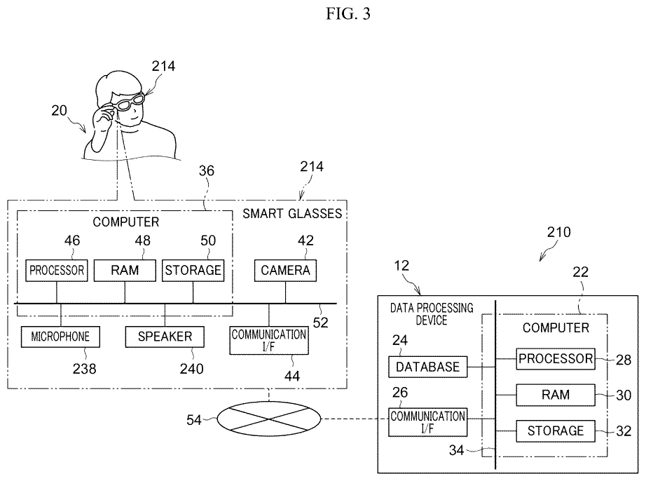

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

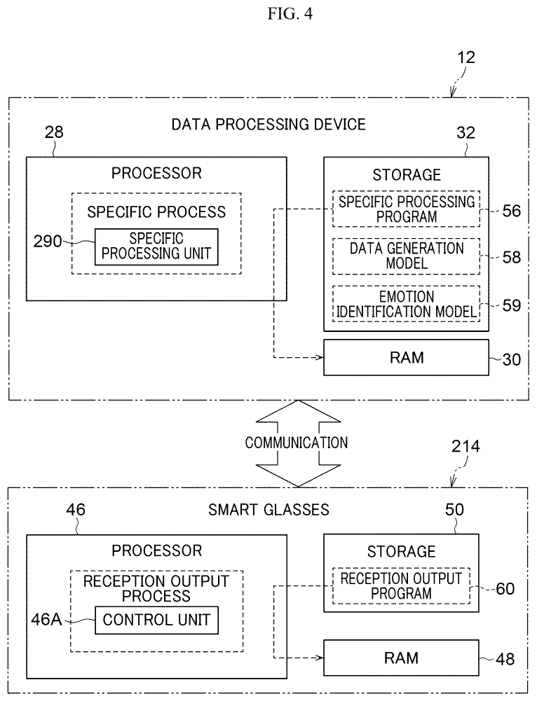

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

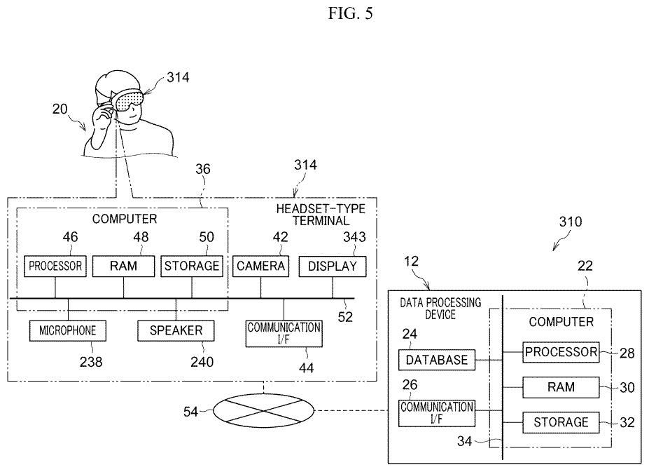

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

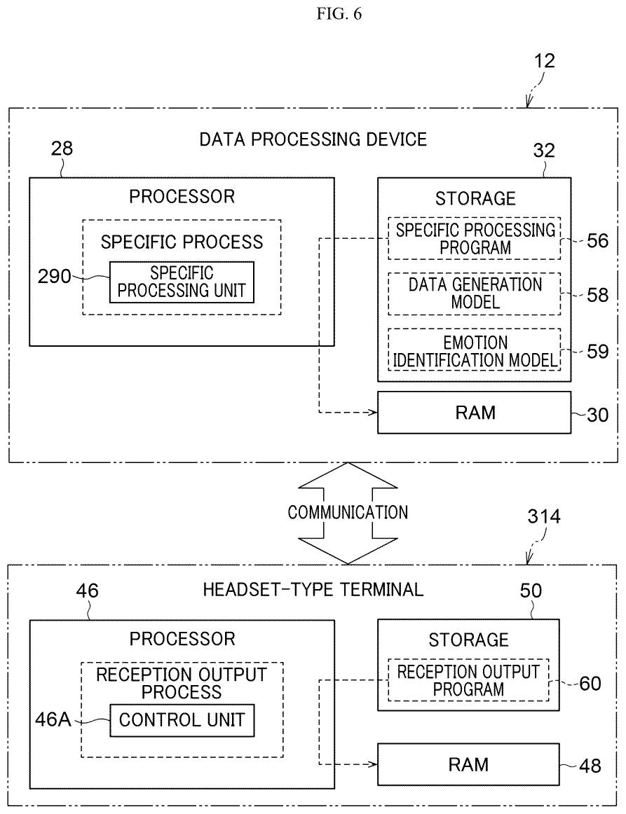

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

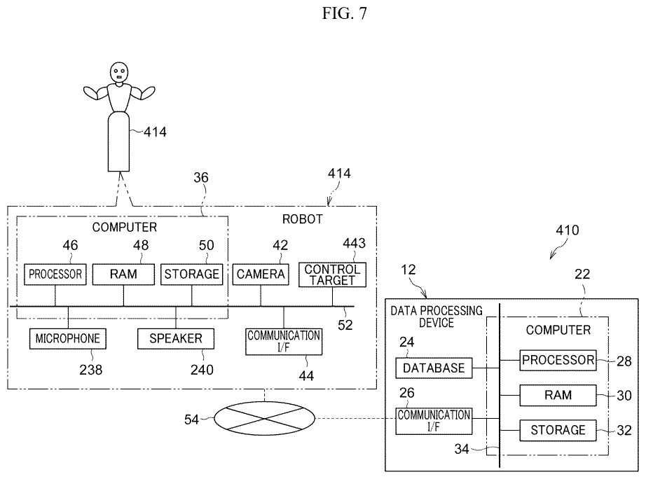

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

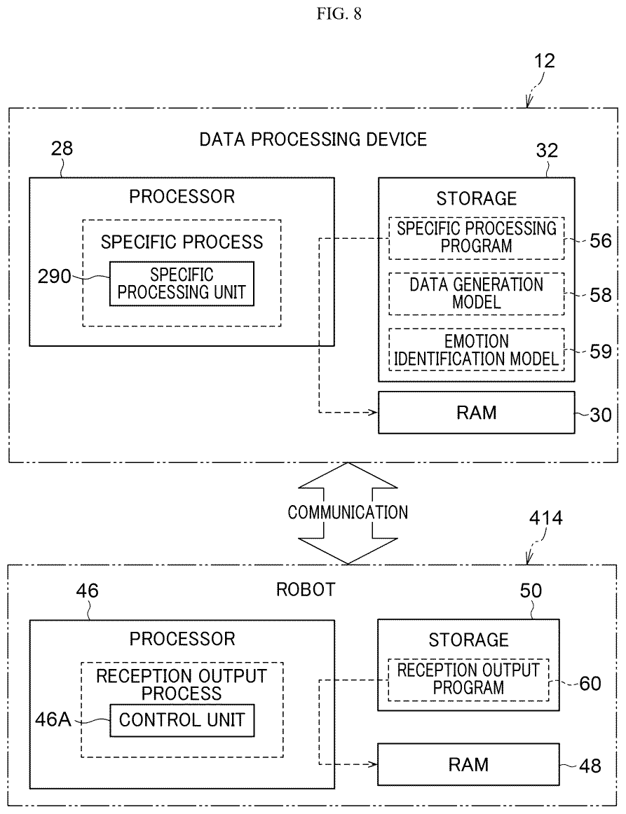

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

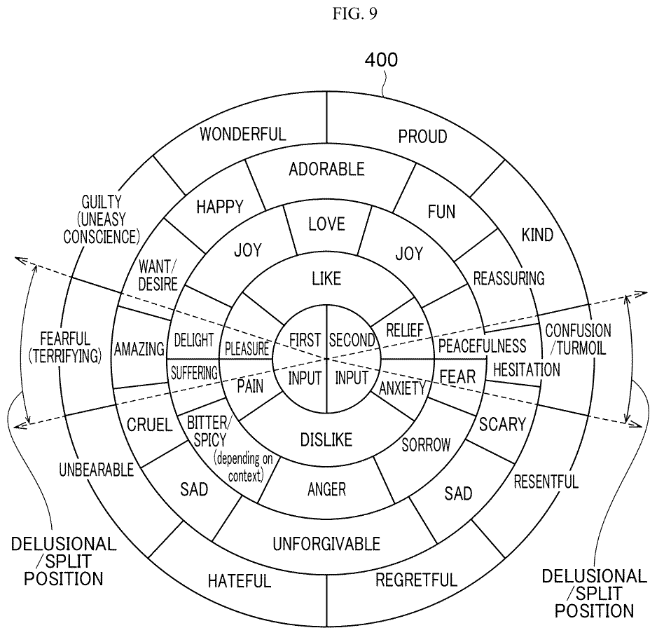

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

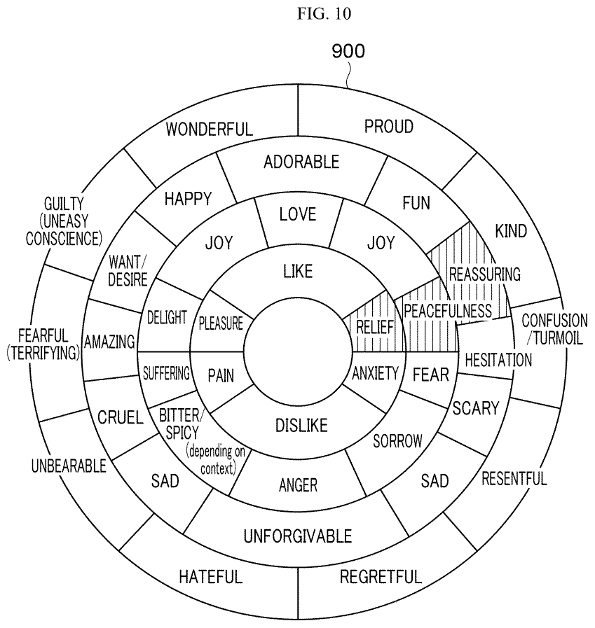

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire external information including recent trend information and broadcast schedule information of information media, sales information, and user emotion information, and perform demand forecasting processing using a machine learning algorithm based on the external information, the sales information, and the user emotion information,
generate order-list information including item information, quantity information, and supply-entity information by using a result of the demand forecasting processing and inventory information, and aggregate the order-list information for each supply entity and transmit the aggregated order-list information to an external information processing apparatus via a communication interface so as to automate ordering processing,
generate a prompt sentence for a generative AI model based on the order-list information and a result of the ordering processing, and acquire advertising text information or advertising configuration information from the generative AI model by using the prompt sentence,
generate layout information for plate-making by associating the advertising text information or the advertising configuration information with the item information and the quantity information included in the order-list information, and automatically generate advertisement data by generating the layout information for plate-making as an electronic document, and transmit the advertisement data and print-condition information to a print processing apparatus via the communication interface, and acquire print request information and print acceptance-state information so as to automate print-order processing.

### (Supplementary 2)

The system according to supplementary 1,
wherein the processor is configured to perform the demand forecasting processing by using feature quantities generated from the sales information and the external information as input to a prediction model including an ensemble of decision-tree models, and to improve demand forecasting accuracy by integrating the user emotion information into the feature quantities.

### (Supplementary 3)

The system according to supplementary 1,
wherein the processor is configured to cause a layout-creation application to operate on a terminal apparatus, execute a script function of the layout-creation application to generate the advertisement data, and automatically arrange the advertising text information acquired from the generative AI model in response to the prompt sentence into predetermined regions of the layout information for plate-making so as to automatically generate a plurality of types of advertisement data.

### Application Example 1

### (Supplementary 1)

A system comprising a processor, and a communication interface coupled to the processor,
wherein the processor is configured to
acquire trend information and scheduled broadcast information of information media from an external information source via the communication interface, integrate the acquired information with historical sales information and stock information, and generate a data set for demand forecasting,
generate demand forecast information by using a learning model including a machine learning algorithm and a generative artificial intelligence model based on the data set for demand forecasting, input scenario information and baseline forecast values into the generative artificial intelligence model as a prompt sentence, obtain correction information for the demand forecast information from the generative artificial intelligence model, and
generate final demand forecast information based on the correction information, calculate required replenishment quantities for individual items based on the final demand forecast information and the stock information, and generate order list information for each supply entity,
transmit order information in an electronic data format corresponding to a specification of each of a plurality of supply entities to information processing apparatuses of the plurality of supply entities via the communication interface based on the order list information, receive response information from the information processing apparatuses of the plurality of supply entities, and manage an order status based on the response information,
extract product attribute information and sales promotion conditions based on the final demand forecast information and the order list information, automatically generate layout information for artwork creation, and automatically generate advertisement print data based on the layout information,
transmit the advertisement print data to an information processing apparatus of a print service provider via the communication interface, receive reception information relating to print processing from the information processing apparatus of the print service provider, and manage a state of advertisement production based on the reception information,
provide display information of the demand forecast information, the order list information, and the advertisement print data to a user terminal apparatus via the communication interface, receive correction instruction information from the user terminal apparatus, and update the order list information and the layout information based on the correction instruction information, and
retransmit updated order list information and updated advertisement print data based on the correction instruction information to the plurality of supply entities and the print service provider via the communication interface, and receive confirmation information from the plurality of supply entities and the print service provider.

### (Supplementary 2)

The system according to supplementary 1,
wherein the processor is configured to use a time-series prediction model as the learning model, learn the historical sales information and the trend information by the time-series prediction model, and numerically correct the final demand forecast information by combining output of the generative artificial intelligence model as the correction information with an output of the time-series prediction model.

### (Supplementary 3)

The system according to supplementary 1,
wherein the processor is configured to communicate with the user terminal apparatus implemented as a portable information terminal, cause the user terminal apparatus to display the demand forecast information and the order list information on a screen, receive operation information including quantity changes and item selections from a user via the user terminal apparatus, and regenerate the order list information and the advertisement print data by reflecting the operation information.

### Example 2

### (Supplementary 1)

A system comprising a processor,
wherein the processor is configured to
acquire trend information, broadcast schedule information of an information medium, sales history information, and emotion information, and perform preprocessing on the acquired information to generate time-series learning data; and
execute demand forecasting processing by applying a machine learning algorithm to the time-series learning data as input, thereby generating a demand forecast result representing future demand; and
generate a procurement list including procurement target items and corresponding quantities based on the demand forecast result and inventory information, transmit electronic order information based on the procurement list to a supplier information processing apparatus via a communication interface using an external connection function, and acquire response information to the order information so as to automatically execute a procurement operation; and
generate a prompt sentence including specifications of an advertising output medium and attributes of listing target items based on at least one of the demand forecast result, the order information, and the response information, and cause a generative artificial intelligence model to operate on external processing resources or internal processing resources by using the prompt sentence as input, thereby generating advertisement image data and layout information; and
generate print data by using the advertisement image data, the layout information, price information, and store identification information, transmit print order information including the print data and print condition information to an output device management system via the communication interface, and acquire response information to the print order information so as to automatically execute a print ordering process; and
transmit state information regarding at least one of the print data and the response information, and preview image data of the advertisement image data, to a portable information terminal via a communication network so as to enable display of the state information and the preview image data on the portable information terminal.

### (Supplementary 2)

The system according to supplementary 1,
wherein the processor is configured to
use, as the machine learning algorithm, a deep learning model that estimates future demand quantities based on time-series data, and integrate the emotion information as a feature into the time-series learning data so as to improve accuracy of the demand forecasting.

### (Supplementary 3)

The system according to supplementary 1,
wherein the processor is configured to
automatically generate the prompt sentence to be input to the generative artificial intelligence model based on the demand forecast result, the procurement list, and advertising target period information, cause generation of a plurality of types of advertisement image data having different design styles and arrangement styles in accordance with content of the prompt sentence, and select at least one of the plurality of types of advertisement image data to be reflected in the print data.

### Application Example 2

### (Supplementary 1)

A system comprising a processor,
wherein the processor is configured to
acquire recent trend information, broadcast schedule information of information media, historical transaction information, and user emotion state information, preprocess the information to generate feature data, and perform demand forecasting using the feature data and a prompt sentence as an input to a generative AI model,
calculate, based on a result of the demand forecasting and inventory information, an order quantity for each order target item, generate order list data for each order target supply entity, generate, based on the order list data, a prompt sentence for automatically executing ordering processing with various supply entities, and transmit the prompt sentence and the order list data via a communication interface so as to automate ordering operations,
extract, based on the order list data and the result of the demand forecasting, advertising information, generate promotion specification data including the advertising information and a prompt sentence as an input to the generative AI model, obtain advertising text information and layout information from the generative AI model using the prompt sentence, generate artwork data using the advertising text information and the layout information, and transmit, via the communication interface, order information based on the artwork data to a print entity that performs print processing so as to automate ordering of advertising printed matter, acquire, from a terminal device, goods in-out information and inventory state information in a retail or logistics site, and reflect the inventory state information in the demand forecasting and generation of the order list data,
acquire, via an imaging mechanism and a sound acquisition mechanism provided in the terminal device, facial expression information and voice information of a user, execute emotion analysis processing to calculate the user emotion state information, integrate the user emotion state information into the feature data to correct the demand forecasting, generate, using a prompt sentence for the generative AI model, promotion display content for an in-store display device according to the user emotion state information, and distribute the promotion display content to the terminal device, and
output, to the terminal device, visualization information of the result of the demand forecasting, the order list data, an ordering status of the advertising printed matter, and a result of the emotion analysis, accept a correction instruction from the user, and update the result of the demand forecasting, the order list data, and the promotion display content based on the correction instruction.

### (Supplementary 2)

The system according to supplementary 1,
wherein the processor is configured to
generate a learning data set obtained by integrating numerical data and categorical data, construct a demand forecasting model using a machine learning algorithm, incorporate the user emotion state information as a feature of the learning data set to improve accuracy of the demand forecasting, generate an explanation prompt sentence including an output result of the demand forecasting model and related aggregate information, input the explanation prompt sentence to the generative AI model, obtain explanation information and adjustment guideline information regarding the result of the demand forecasting from the generative AI model, and correct the result of the demand forecasting based on the explanation information and the adjustment guideline information.

### (Supplementary 3)

The system according to supplementary 1,
wherein the processor is configured to
acquire free-text information from the user at the terminal device, perform intent classification and importance determination of the free-text information by a natural language processing method, generate a prompt sentence including the free-text information and an analysis result, input the prompt sentence to the generative AI model to obtain department information or response procedure information, automatically distribute the free-text information to a related processing system or business entity based on the department information or the response procedure information, extract emotion state information included in the free-text information, and reflect the emotion state information in the demand forecasting and the generation of the order list data.

What is claimed is:

1. A system comprising:
circuitry configured to
acquire, via a communication interface coupled to a packet-switched network, heterogeneous time-series data from one or more external data sources, the heterogeneous time-series data comprising trend data, scheduled event data of an information medium, historical transaction data, and state data derived from analysis of input signals,
preprocess the heterogeneous time-series data to generate feature vectors by performing temporal alignment, numerical encoding, and categorical encoding, and store the feature vectors in a storage device,
apply an ensemble prediction model comprising a plurality of decision-tree models to the feature vectors to compute a forecast output representing predicted quantities for a set of items over a future time interval,
generate, based on the forecast output and current availability data, structured allocation data comprising item identifiers, quantity values, and entity identifiers grouped by target entity,
transmit, via the communication interface, the structured allocation data in an electronic data format to one or more external information processing apparatuses, and receive response data from the one or more external information processing apparatuses to update a status record in the storage device,
generate a structured prompt data structure based on the structured allocation data and the response data, input the structured prompt data structure into a generative neural network model, and receive from the generative neural network model content data and configuration data, and
generate electronic document data by associating the content data and the configuration data with attribute data derived from the structured allocation data according to a predefined template structure, and transmit, via the communication interface, the electronic document data together with output condition data to an output processing apparatus.

2. The system according to claim 1, wherein the circuitry is further configured to integrate the state data as additional feature components within the feature vectors prior to applying the ensemble prediction model, wherein the state data comprises numerical values derived from emotion analysis processing applied to text or interaction signals received from a terminal device.

3. The system according to claim 2, wherein the circuitry is further configured to acquire, via an imaging mechanism and a sound acquisition mechanism of a terminal device, facial expression data and voice data, perform emotion analysis processing on the facial expression data and the voice data using a trained neural network model, and compute the state data as a multi-dimensional vector representing emotional dimensions.

4. The system according to claim 3, wherein the circuitry is further configured to generate, using a prompt sentence for the generative neural network model, display content conditioned on the state data, and distribute the display content to the terminal device for presentation on a display device.

5. The system according to claim 1, wherein the ensemble prediction model further comprises a time-series prediction component, and the circuitry is further configured to generate baseline forecast data using the time-series prediction component, generate a prompt sentence including scenario data and the baseline forecast data, input the prompt sentence into the generative neural network model to obtain correction data, and compute the forecast output by numerically combining the baseline forecast data with the correction data.

6. The system according to claim 5, wherein the circuitry is further configured to generate the prompt sentence by encoding trend indicators, temporal event flags, and historical quantity summaries as structured context fields within the prompt sentence.

7. The system according to claim 1, wherein the circuitry is further configured to aggregate the structured allocation data by grouping item identifiers and quantity values according to entity identifiers, and transmit entity-specific electronic data to respective external information processing apparatuses using entity-specific communication protocols.

8. The system according to claim 7, wherein the circuitry is further configured to receive acceptance state data and processing state data from the external information processing apparatuses, and update the status record in the storage device to reflect a current processing state for each entity.

9. The system according to claim 8, wherein the structured allocation data comprises procurement target items and corresponding quantities for replenishment based on a difference between the forecast output and the current availability data.

10. The system according to claim 1, wherein the structured prompt data structure includes specification data of an output medium, attribute data of target items, and promotional condition data, and the generative neural network model generates a plurality of content data variants having different layout styles in accordance with the structured prompt data structure.

11. The system according to claim 10, wherein the circuitry is further configured to select at least one content data variant from the plurality of content data variants based on a selection criterion, and incorporate the selected content data variant into the electronic document data.

12. The system according to claim 11, wherein the circuitry is further configured to generate the electronic document data as print-ready layout data by arranging the content data, price attribute data, and entity identification data into predetermined regions of a template layout structure.

13. The system according to claim 12, wherein the circuitry is further configured to transmit the electronic document data and print condition data to the output processing apparatus via the communication interface, receive print acceptance data from the output processing apparatus, and update a production state record in the storage device.

14. The system according to claim 1, wherein the circuitry is further configured to cause a layout-creation application executing on a terminal apparatus to generate the electronic document data by invoking a script function of the layout-creation application that arranges the content data received from the generative neural network model into predetermined regions of the template structure.

15. The system according to claim 1, wherein the circuitry is further configured to receive, from a terminal device at a physical site, goods movement data and availability state data, update central availability records in the storage device based on the goods movement data, and reflect the updated availability records in subsequent executions of the forecast output computation and the structured allocation data generation.

16. The system according to claim 15, wherein the circuitry is further configured to transmit, via the communication interface, visualization data representing the forecast output, the structured allocation data, a processing status of the electronic document data, and the state data to the terminal device for display.

17. The system according to claim 16, wherein the circuitry is further configured to receive correction input data from the terminal device, and update at least one of the forecast output, the structured allocation data, and the content data according to the correction input data.

18. A system comprising:
circuitry configured to
acquire, via a communication interface coupled to a packet-switched network, heterogeneous time-series data comprising trend data, scheduled event data, historical transaction data, and state data derived from emotion analysis processing,
preprocess the heterogeneous time-series data into feature vectors by performing temporal alignment, numerical encoding, and categorical encoding,
apply an ensemble prediction model comprising a plurality of decision-tree models to the feature vectors and generate baseline forecast data, generate a prompt sentence encoding scenario data and the baseline forecast data, input the prompt sentence into a generative neural network model to obtain correction data, and compute a forecast output by numerically combining the baseline forecast data with the correction data,
generate structured allocation data comprising item identifiers, quantity values, and entity identifiers based on the forecast output and availability data, and transmit entity-specific electronic data to external information processing apparatuses via the communication interface,
generate a structured prompt data structure based on the structured allocation data, input the structured prompt data structure into the generative neural network model to receive content data and layout configuration data, and generate electronic document data by associating the content data and the layout configuration data with attribute data according to a template structure, and
transmit the electronic document data and output condition data to an output processing apparatus via the communication interface, and receive processing state data from the output processing apparatus to update a status record in a storage device.

19. The system according to claim 18, wherein the circuitry is further configured to receive goods movement data from a terminal device, update availability records in the storage device, and reflect the updated availability records in subsequent computation of the forecast output and the structured allocation data.

20. A method comprising:
acquiring, via a communication interface coupled to a packet-switched network, heterogeneous time-series data from one or more external data sources, the heterogeneous time-series data comprising trend data, scheduled event data of an information medium, historical transaction data, and state data derived from analysis of input signals;
preprocessing the heterogeneous time-series data to generate feature vectors by performing temporal alignment, numerical encoding, and categorical encoding;
applying an ensemble prediction model comprising a plurality of decision-tree models to the feature vectors to compute a forecast output representing predicted quantities for a set of items over a future time interval;
generating, based on the forecast output and current availability data, structured allocation data comprising item identifiers, quantity values, and entity identifiers grouped by target entity;
transmitting, via the communication interface, the structured allocation data in an electronic data format to one or more external information processing apparatuses, and receiving response data from the one or more external information processing apparatuses;
generating a structured prompt data structure based on the structured allocation data and the response data, inputting the structured prompt data structure into a generative neural network model, and receiving from the generative neural network model content data and configuration data; and
generating electronic document data by associating the content data and the configuration data with attribute data derived from the structured allocation data according to a predefined template structure, and transmitting, via the communication interface, the electronic document data together with output condition data to an output processing apparatus.
